(19) United States
(12) Patent Application Publication
(10) Pub. No.: US 2026/0337106 A1
(43) Pub. Date: Oct. 29, 2026

(54) Pre-mix Compositions Containing Silica Fume, Silica Flour, and Ceramic Microspheres, and Uses for same

(71) Applicants: Richard Archie Burgess, IV, Manassas, VA (US); Richard Archie Burgess, III, Manassas, VA (US)

(72) Inventors: Richard Archie Burgess, IV, Manassas, VA (US); Richard Archie Burgess, III, Manassas, VA (US)

(21) Appl. No.: 19/726,847

(22) Filed: Jun. 30, 2026

Related U.S. Application Data
(63) Continuation-in-part of application No. 18/484,456, filed on Oct. 11, 2023, now Pat. No. 12,668,540.
Application No. 18/484,456 is a continuation-in-part of application No. PCT/US22/31480, filed on May 28, 2022.
(60) Provisional application No. 63/343,103, filed on May 18, 2022.

(51) Int. Cl. C04B 28/04; C04B 14/06; C04B 14/22; C04B 14/48; C04B 18/14; C04B 20/00; C04B 22/08; C04B 40/00; C04B 103/32; C04B 103/61

(52) U.S. Cl. CPC C04B 28/04; C04B 14/06; C04B 14/22; C04B 14/48; C04B 18/146; C04B 20/004; C04B 22/085; C04B 40/0042; C04B 40/0046; C04B 40/0082; C04B 2103/32; C04B 2103/61; C04B 2201/52

(57) ABSTRACT

The invention relates to processes for making an ultra high performance concrete (UHPC) dry pre-mix for use in manufacturing microfiber reinforced ultra high performance concrete using recycled glass powder and articles made from the same. The invention also includes a process of mixing fine aggregate, cement, and the UHPC dry pre-mix comprising 2.5-6.0 micron recycled glass powder, silica fume, silica flour, ceramic microspheres, and optional microinclusions to obtain a UHPC dry mix, followed by adding water only, with further mixing, then adding a combination of two or more admixes to make an ultra high performance concrete cement mix paste, followed by adding microfibers such as steel microfibers that are 13 mm×0.2 mm to make a microfiber reinforced UHPC product.

### BACKGROUND OF THE INVENTION

### Field of the Invention

The invention relates to pre-mix compositions containing silica fume, silica flour, and ceramic microspheres, and uses for the same, including in compositions and processes for making improved ultra high performance concrete with microfiber and recycled glass powder, and articles made from the same.

### Description of the Related Art

Durable construction materials come in many forms. However, there is still a need for improved compositions having properties desirable in construction projects. The use of waste glass powder as a partial substitute for portland cement in concrete provides a pozzolanic (cementing) function.

U.S. Pat. No. 7,775,466 to Grasso for “Production of glass powder from waste glass” discusses a clean dry glass powder useful as a substitute for Portland cement in concrete, in paints, and for other known uses for glass powder produced conventionally can be produced from unsorted post-consumer waste glass, including a substantial fraction of non-glass items, by employing glass pulverizing equipment to reduce waste glass to small fragments, allowing removal of trash, employing a multistep washing process to clean the glass fragments, in the preferred embodiment using aggregate cleaning equipment, drying the fragments, preferably using fluidized bed techniques, and grinding the glass to a desired particle size, preferably using a ball mill, in combination with an air classification step to produce a glass powder of uniform particle size.

U.S. Pat. No. 6,296,699 to Jin for “Inorganic binders employing waste glass” discusses using waste glass powder in concrete and “artificial stone”. An alkali metal activator, for example, an alkali metal hydroxide, silicate, aluminate, carbonate, sulfate, phosphate or fluoride is mixed with the glass powder and water, and this material cured, in some examples at room temperature. Jin teaches that the waste glass should be cleaned in advance to remove residues such as sugar from the waste glass which can affect the setting and binding of the concrete. He further states that the processes used to create glass powder from waste glass, e.g., ball milling and pulverizing, are well known.

In a report titled “Recycling of Crushed Glass into Coating Products”, CWC Report No. GL-96-1 (1998) the authors state that “paint and coating applications are especially sensitive to organic contamination. For example, one unwashed jar of mayonnaise could provide enough residue to bacterially contaminate many gallons of paint.”

Vitunac et al U.S. Pat. Nos. 5,350,121 and 5,246,174 show methods for recycling glass, directed primarily to recycling of TV picture tubes, with much attention to removing heavy metals, coatings and the like. Pulverizing, washing, rinsing and further crushing steps are disclosed generally.

Abernathy U.S. Pat. No. 4,030,670 shows a trash recycling system including separation of various sorts of trash. Glass fragments are washed and dried.

Morey et al U.S. Pat. No. 4,067,502 and Morey U.S. Pat. No. 4,070,273 show flotation separation of glass fragments (up to 10 mesh) using amines as beneficiation agents.

Baxter U.S. Pat. No. 5,803,960 shows making glass for concrete reinforcement, while avoiding the alkali-silica reaction (ASR) by mixing a lithium-containing composition with crushed bottle glass. The glass may be provided in powder or fibrous form. Baxter et al U.S. Pat. No. 5,810,921 shows a similar invention using chromium instead of lithium.

Pelot et al U.S. Pat. Nos. 6,344,081 and 6,699,321 show concrete compositions, and emphasize the use of “electric” or “E-glass” powder of between 100 and 325 mesh in concrete. The claims require the glass particles to be no larger than 80-120 mesh, 40-60% between 180 and 220 mesh, and 10-30% less than 325 mesh; the cement used is to be low-alkali. The glass is to comprise up to 25% of the mix.

Bergart U.S. Pat. Nos. 5,950,936 and 6,168,102 show a system for recycling glass from a post-consumer waste glass stream including other sorts of debris. The process steps include various sorting, screening, crushing, presoaking, washing, dewatering, and drying steps. If a glass powder is desired, second crushing and separation steps may be included. The dewatering step can be performed using a rotary screw conveyor (col. 4, line 32 of the '936 patent), and the drying step using a fluidized bed dryer (col. 4, line 44). It is acknowledged that some ceramic content will remain, and it is asserted that if the ceramic content is not acceptable to the end user, a second crushing stage can be performed to form a fine glass powder; the “ceramic particles dispersed throughout the glass powder will dissipate in further processing”. Col. 5, lines 48-52.

Kimmel et al U.S. Pat. No. 6,112,903 shows a method for sorting various types of glass from one another. A stream of glass cullet mixed with other items is heated using microwave energy; as different types of glass and items of other materials absorb different amounts of energy, they are differentially heated, and can be differentiated in a digital image made by a thermal imaging camera. A downstream diverter mechanism can then be used to separate out various constituents of the stream. Kimmel et al U.S. Pat. No. 6,464,082 shows a complete system employing this technique.

Harada U.S. Pat. Nos. 6,250,576 and 6,446,884 show a method and system for producing glass sands by crushing and agitating steps.

Sunde U.S. Pat. No. 6,743,287 shows a concrete using relatively large glass particles, requiring addition of a “non-alkali reactive mineral”, e.g. granite.

Whaley U.S. Pat. No. 6,770,328 shows a method of making a terrazzo surface using recycled glass in an epoxy matrix. Preparation of the glass is not discussed.

Thus, although the prior art discusses the use of waste glass powder in various applications, in particular as a partial substitute for portland cement in concrete, there is still a need to improve the manufacturing process for ultra high performance concrete, known for having psi strength of 21,000 psi or more.

### SUMMARY OF THE INVENTION

Accordingly, the invention provides pre-mix compositions containing silica fume, silica flour, and ceramic microspheres, and uses for the same, including in compositions and processes for making improved ultra high performance concrete with microfiber and recycled glass powder, and articles made from the same.

These inventive compositions and processes are useful in manufacturing microfiber reinforced ultra high performance concrete by mixing sand, portland cement, and a dry mixture of constituents consisting of 2.5-6.0 micron recycled glass powder, silica fume, silica flour, ceramic microspheres with average D50 diameter 4 microns, and optionally microinclusions, to yield a UHPC dry mix, then first mixing water into the UHPC dry mix, followed by mixing an admix combination of high-range water-reducing (HRWR) admix and super-plasticizer admix, to form a UHPC cement-containing paste of uniform plasticity, and finally mixing microfibers to the UHPC cement-containing paste of uniform plasticity to obtain a microfiber reinforced UHPC cement mix.

The microfiber reinforced UHPC paste is used to manufacture components selected from the group consisting of: an overlay, a joint fill, a beam end-cap, a plate, a channel, a pipe, a tube, an I-beam section, an H-beam component, a WF-section, a smooth column, a fluted column, a connector, a precast highway slab, a precast railroad tie, a precast parking block, a precast jersey barrier, a street curb, a sidewalk, a driveway, a drive apron, a guard rail, a bollard, vehicle up-armoring, ballistic armor for walls and doors, an armored roofing tile, a ballistic panel for a building, a ships, an aircraft, a truck, and a passenger vehicle, a ballistic floor tile, a blast-resistant panel, a man-portable panel, a thin armor panel, a forced entry resistant structural elements, a wall, a slab, a truss, a joist, a rafter, a support gusset, a footer, an underflooring, a concrete block, a brick, a panel, a roofing tile, a siding plank, a mounting pad, a paver, a post and pole anchor block, a floor tile, a kitchen tile, a bath tile, a kitchen and bath countertop, a laboratory bench top, a fireplace liner, a veneer, a decking plank, a post, a support, a planter, a paver, a stepping stone, a bench, a fireplace, a gutter, a drainage tile, an in situ poured water conduit and structure, a precast water conduit, in situ poured sewer pipe and structure, a precast sewage pipe, an in situ poured connector, a precast connector, a seawall, a sea barrier block and form, a waterway bridge piling, a waterway bridge span, column, and decking, a building piling, span, column and slab, an undersea piling, an undersea mounting pad, an undersea coffer dam having a cement base and a UHPC cap layer, a harbor dock, a marina piling, a dock, a navigation structure, a lighthouse, a waterway navigation light and structure, a boat launch ramp, a reservoir liner and wall, a mounting pad, a post and pole anchor block, a warehouse slab, a holding pond, a spillway, a silo, a loading dock, a security barrier, a traffic diversion structure, a gatehouse, a solar panel pad, a wind turbine slab, a wind turbine tower, a smokestack, a refractory furnace brick, an oil and gas well cementing for casings, a storage tank pad, a drilling slab, a pump jack slab, a pipeline footer, a spillway for oil and gas, a holding pond for oil and gas, a protective utility box, a security wall, an offshore rig structural component, a power transmission tower, a power substation security wall, a water control dam and aquaduct, a electrical utility pole and tower, an electrical utility (junction) box, a natural gas utility box, a telecommunication utility pole, a telecommunication utility (junction) box, a telecommunication (telephone) pole, and mobile cell phone tower, and combinations thereof.

The invention also provides a UHPC dry pre-mix comprising a dry mixture of constituents consisting of 2.5-6.0 micron recycled glass powder, silica fume, silica flour, ceramic microspheres, and optionally microinclusions.

The compositions may also be cured to achieve enhanced strength by placing in an environment of heat and optionally humidity or submersion at approximately 120-195 °F for about one to about four days.

In another preferred embodiment of the invention, there is provided a component, comprising: a form made using the composition(s) described herein, wherein the component has a strength of at least 17,000-25,000 psi, or has a strength of over 21,000 psi, or is heat and/or moisture cured and has a strength of over 21,500 psi, or is voltage cured and has a strength over 21,500 psi.

### BRIEF DESCRIPTION OF THE FIGURES

FIG. 1 is a process flowchart of another preferred process for preparing UHPC dry pre-mix.

FIG. 2 is a process flowchart of another preferred process for preparing UHPC dry pre-mix having 2.5-6.0 micron recycled glass powder.

FIG. 3 is a process flowchart illustrating preparing micro-fiber reinforced UHPC paste.

FIG. 4 is a process flowchart illustrating preparing micro-fiber reinforced UHPC paste with glass powder.

FIG. 5—preparing multi-fiber reinforced UHPC paste with two-part admix and optional corrosion inhibitor

FIG. 6 is a process flowchart illustrating preparing a UHPC component in a form.

FIG. 7 is a process flowchart illustrating preparing a cured UHPC component.

FIG. 8 is a process flowchart illustrating the process for preparing a microfiber reinforced UHPC paste.

FIG. 9 is a process flowchart illustrating the process for preparing a UHPC component having microinclusions.

FIG. 10 is a table showing CorTuf microfiber reinforced UHPC properties.

FIG. 11 is a table showing psi strength after 3-day and 7-day curing periods for a mix designs compared to no fiber mixes, “UH-FIBER”, “DD FIBER”, and “3D mix”.

FIG. 12 is a table showing psi strength after 5-day and 7-day curing periods for a mix design “Day 1”.

FIG. 13 is an image of an H pile constructed using the microfiber reinforced UHPC herein.

FIG. 14 is a table of microfiber reinforced UHPC constituents, packaging, and yield.

FIG. 15 is an image of a precast form (wall) made from a unitary pour of microfiber reinforced UHPC.

FIG. 16 is a table of microfiber reinforced UHPC testing results.

FIG. 17 is an image of a processing plant. FIG. 15 shows a mobile trailer having hopper bins connected by feeders/augers for sand, cement, UHPC additive, and microfibers, as well as containers for dispensing admix and water.

FIG. 18 is a process flowchart illustrating the process for preparing a mix UHPC concrete.

FIG. 19 is a process flowchart illustrating the process for preparing a Sustainable UHPC concrete having a 50% replacement of silica fume.

FIG. 20 is a process flowchart illustrating the process for preparing a Reduced cost UHPC concrete.

FIG. 21 is a process flowchart illustrating the process for preparing a Summer mix UHPC concrete.

FIG. 22 is a process flowchart illustrating the process for preparing a 40H-50S mix UHPC concrete.

### DETAILED DESCRIPTION

Disclosed herein are embodiments directed to pre-mix compositions containing silica fume, silica flour, and ceramic microspheres, and uses for the same, including in compositions and processes for making improved ultra high performance concrete with microfiber and recycled glass powder, and articles made from the same. The inventive compositions are useful in manufacturing ultra high performance concrete by a sequential process of mixing dry constituents of fine aggregate (sand), cement, and a dry pre-mix comprised of silica fume, silica flour, and ceramic microspheres with average D50 diameter 4 microns to obtain a UHPC dry mix, with optional 2.5-6.0 micron recycled glass powder, followed by adding water only, with further mixing, then adding a combined water-reducing admix and a superplasticizer admix, to obtain a UHPC cement-containing paste of uniform plasticity, and finally mixing microfibers to the UHPC cement-containing paste of uniform plasticity to obtain a microfiber reinforced UHPC paste.

In one of the preferred embodiments of the invention, there is provided a process for making UHPC dry pre-mix, comprising: mixing silica fume 20-45 weight %, silica flour 15-25 weight %, and ceramic microspheres 30-65 weight %, to obtain a UHPC dry pre-mix.

In another one of the preferred embodiments of the invention, there is provided a process for making UHPC dry pre-mix, comprising: mixing silica fume 20-45 weight %, silica flour 15-25 weight %, ceramic microspheres 17-22 weight %, and 2.5-6.0 micron (D50) recycled glass powder 15-60 weight %, to obtain a UHPC dry pre-mix.

Any of the embodiments may include a UHPC dry mix made according to the process, and may also include the UHPC dry mix packaged in a 20-50 lb bag.

Any of the embodiments may also include wherein 2.5-6.0 micron (D50) recycled glass powder comprises 17.24-18.42 weight %, silica fume comprises 41.38-36.84 weight %, silica flour comprises 23.68-24.14 weight %, and ceramic microspheres comprise 17.24-21.05 weight %, wherein a total of all dry weight % equals 100%.

Any of the embodiments may include wherein 2.5-6.0 micron (D50) recycled glass powder comprises 52-60 weight %, silica fume comprises 0-2 weight %, silica flour comprises 23.68-24.14 weight %, and ceramic microspheres comprise 17.24-21.05 weight %, wherein a total of all dry weight % equals 100%.

Any of the embodiments may include wherein 2.5-6.0 micron (D50) recycled glass powder comprises 40-46 weight %, silica fume comprises 18-20 weight %, silica flour comprises 23.68-24.14 weight %, and ceramic microspheres comprise 13-16 weight %, wherein a total of all dry weight % equals 100%.

Any of the embodiments may include wherein 2.5-6.0 micron (D50) recycled glass powder comprises 55-58 weight %, silica fume comprises 18-20 weight %, silica flour comprises 12 weight %, and ceramic microspheres comprise 9-10 weight %, wherein a total of all dry weight % equals 100%.

In one of the preferred embodiments of the invention, the process comprises (1) mixing fine aggregate 28-45 weight %, portland cement 28-45 weight %, and a dry pre-mix comprised of silica fume 4-12 weight %, silica flour 4-12 weight %, ceramic microspheres 5-15 weight %, and optionally 2.5-6.0 micron recycled glass powder 5-15 weight %, and optionally microinclusions to obtain a UHPC dry mix; (2) mixing water 0.15-0.25 w/c ratio into the UHPC dry mix to obtain a hydrated UHPC paste; and then (3) mixing a high-range water-reducing admixture combination consisting of a high-range water-reducing liquid admixture and a superplasticizer liquid admixture into the hydrated UHPC paste to obtain a flowable UHPC cement-containing paste of uniform plasticity, and finally (4) mixing microfibers averaging 10-20 mm in length at 5-10 weight % into the flowable UHPC cement-containing paste of uniform plasticity to obtain a microfiber reinforced UHPC paste.

Any of the UHPC dry mix embodiments may include wherein the (i) fine aggregate is 38-43 weight %, the (ii) portland cement is 37-41 weight %, and the dry pre-mix is comprised of silica fume 4-12 weight %, silica flour 4-12 weight %, ceramic microspheres 5-15 weight %, optional 2.5-6.0 micron (D50) recycled glass powder 5-15 weight %, and optional microinclusions, wherein a total of all dry weight % equals 100%.

In one non-limiting preferred embodiment, there is provided an embodiment directed to UHPC dry pre-mix and processes for making UHPC dry pre-mix comprising: mixing (i) silica fume 20-45 weight %, (ii) silica flour 15-25 weight %, and (iii) ceramic microspheres 30-65 weight % to obtain a UHPC dry pre-mix.

In another non-limiting preferred embodiment, there is provided an embodiment directed to UHPC dry pre-mix and processes for making UHPC dry pre-mix comprising: mixing (i) silica fume 20-45 weight %, (ii) silica flour 15-25 weight %, and (iii) ceramic microspheres 17-22 weight %, and (iv) 2.5-6.0 micron recycled glass powder 15-60 weight %, to obtain a UHPC dry pre-mix.

Any of the UHPC dry pre-mix compositions may include additional microinclusions.

Any of the dry pre-mix embodiments may include wherein the 2.5-6.0 micron (D50) recycled glass powder comprises at least 50 weight %, silica fume comprises at least 25 weight %, silica flour comprises 16-20 weight %, and ceramic microspheres comprise 5-9 weight %, wherein a total of all dry weight % equals 100%.

Any of the dry pre-mix embodiments may include wherein the 2.5-6.0 micron (D50) recycled glass powder comprises 40-46 weight %, silica fume comprises 18-20 weight %, silica flour comprises 23.68-24.14 weight %, and ceramic microspheres comprise 13-16 weight %, wherein a total of all dry weight % equals 100%.

Any of the dry pre-mix embodiments may include wherein the 2.5-6.0 micron (D50) recycled glass powder comprises 55-58 weight %, silica fume comprises 18-20 weight %, silica flour comprises 12 weight %, and ceramic microspheres comprise 9-10 weight %, wherein a total of all dry weight % equals 100%.

Any of the microfibers may include steel fiber, metal fiber, and chopped strand fiber ranging in size from about 10-200 micron diameter by 10-20 mm in length. In a preferred embodiment, the microfiber is steel fiber. In a preferred embodiment, the size is 200 micron×13 mm. In another preferred embodiment, the size is 200 micron×6 mm, especially useful for filling areas needing repair.

Any of the microfibers comprising chopped strand fiber may be selected from the group consisting of Basalt, Glass, Carbon, Synthetic polymer, Natural fiber, and multiple strand threads of one or more of the above.

Any of the synthetic polymer fiber may include fibers made from Polyester (PE), including UHMWPE, aromatic polyester such as Vectran liquid-crystal polymer (LCP), Polyamides including Acrylic, Polyacrylonitrile, and Nylon, Aramids including Kevlar, Twaron, Nomex, and Technora, acrylics made from Polyester+polyamide 80/20 70/30, Polyolefins including polyethylene+polypropylene, Polyester+polyamide+polypropylene, Polyethylteraphthalate (PET), Polystyrene (PS), Acrylonitrile butadiene stryene (ABS), Polyvinyl chloride, Modacrylic, and strand combinations thereof.

Any of the natural fiber may include fibers made from Cellulose, Bagasse, Bamboo, Cotton, Flax, Hemp, Jute, Pine, Silk, Sisal, Wood, Wool, and strand combinations thereof.

Any of the additional microinclusion forms may include powder, grit, turnings, dust, flour, ribbon, shavings, nano- and micro-spheres, fibers, wire, microparticles, nanoparticles, complexes, aggregates, and mixtures thereof. Any additional microinclusion materials selected from the group consisting of: cenospheres, metal forms, alloy forms, steel forms, synthetic forms, polymer forms, natural inorganic forms, mineral forms, glass forms, asbestos forms, carbon forms, cellulose forms, synthetic organic forms, natural organic forms, sisa formsl, and combinations thereof.

Any of the embodiments herein may include recycled glass powder having an average size (D50) of 4 microns. Other embodiments may include a range wherein recycled glass powder has an average size (D50) of 2.5-6.0 microns.

Any of the embodiments may include a second component of recycled glass powder having an average size (D50) of 5-50 microns. Other second component embodiments may include a range wherein a second component of recycled glass powder has an average size (D50) of about 20-200 microns.

Any of the embodiments herein may include wherein said high-range water-reducing admixture amount ranges from about 40-60 fluid ounces per 100 lb of said resultant cement-containing paste, and said superplasticizer+HRWR admixture amount ranges from 1-40 fluid ounces per 100 lb.

Any of the embodiments herein may include wherein said microfiber reinforced UHPC cement-containing paste is used to manufacture components are selected from the group consisting of: an overlay, a joint fill, a beam end-cap, a plate, a channel, a pipe, a tube, an I-beam section, an H-beam component, a WF-section, a smooth column, a fluted column, a connector, a precast highway slab, a precast railroad tie, a precast parking block, a precast jersey barrier, a street curb, a sidewalk, a driveway, a drive apron, a guard rail, a bollard, vehicle up-armoring, ballistic armor for walls and doors, an armored roofing tile, a ballistic panel for a building, a ships, an aircraft, a truck, and a passenger vehicle, a ballistic floor tile, a blast-resistant panel, a man-portable panel, a thin armor panel, a forced entry resistant structural elements, a wall, a slab, a truss, a joist, a rafter, a support gusset, a footer, an underflooring, a concrete block, a brick, a panel, a roofing tile, a siding plank, a mounting pad, a paver, a post and pole anchor block, a floor tile, a kitchen tile, a bath tile, a kitchen and bath countertop, a laboratory bench top, a fireplace liner, a veneer, a decking plank, a post, a support, a planter, a paver, a stepping stone, a bench, a fireplace, a gutter, a drainage tile, an in situ poured water conduit and structure, a precast water conduit, in situ poured sewer pipe and structure, a precast sewage pipe, an in situ poured connector, a precast connector, a seawall, a sea barrier block and form, a waterway bridge piling, a waterway bridge span, column, and decking, a building piling, span, column and slab, an undersea piling, an undersea mounting pad, an undersea coffer dam having a cement base and a UHPC cap layer, a harbor dock, a marina piling, a dock, a navigation structure, a lighthouse, a waterway navigation light and structure, a boat launch ramp, a reservoir liner and wall, a mounting pad, a post and pole anchor block, a warehouse slab, a holding pond, a spillway, a silo, a loading dock, a security barrier, a traffic diversion structure, a gatehouse, a solar panel pad, a wind turbine slab, a wind turbine tower, a smokestack, a refractory furnace brick, an oil and gas well cementing for casings, a storage tank pad, a drilling slab, a pump jack slab, a pipeline footer, a spillway for oil and gas, a holding pond for oil and gas, a protective utility box, a security wall, an offshore rig structural component, a power transmission tower, a power substation security wall, a water control dam and aquaduct, a electrical utility pole and tower, an electrical utility (junction) box, a natural gas utility box, a telecommunication utility pole, a telecommunication utility (junction) box, a telecommunication (telephone) pole, and mobile cell phone tower.

Any of the embodiments herein may include wherein said components are employed to fabricate items selected from the group consisting of: vehicle up-armoring, ballistic armor, blast-resistant panels, man-portable panels, thin armor panels, forced entry resistant structural walls, panels, and supports, armored roofing tiles, ballistic wall panels, ballistic floor tiles, hurricane and tornado resistant structural elements, and combinations thereof.

In another preferred embodiment, the invention provides a method of producing a component of a structure, comprising: (i) Preparing a uniform microfiber reinforced UHPC cement-containing paste according to the processes herein; and (ii) Forming said microfiber reinforced UHPC cement-containing paste in the shape of said component, and curing by heating and/or hydrating said formed microfiber reinforced UHPC paste.

In another preferred embodiment, the invention provides a method as described and claimed wherein said forming is done by techniques selected from the group consisting of: spin casting, extrusion molding, pressure molding, pouring into forms, and combinations thereof.

In another preferred embodiment, the invention provides a method as described and claimed wherein said composition component is cured by: applying heat and/or hydration, either humidity or submersion in water, to harden a poured (in situ) or formed (pre-cast) ultra high performance concrete article. The curing process increases the strength of the ultra high performance concrete article from 17,000 psi to over 21,500 psi. Curing, in a non-limiting embodiment, can include placing in an environment of heat and optionally humidity or submersion at approximately 120-195 °F for about one to about four days. Cured UHPC is governed by ASTM C1856. Field curing of the inventive steel microfiber reinforced (SMR) ultra high performance concrete (UHPC) can, in a non-limiting embodiment, be performed at 150 °F for 2-4 days.

In another preferred embodiment of the invention, there is provided a component, comprising: a form made using the composition(s) described herein, wherein the component has a strength of at least 10,000 psi.

In another preferred embodiment, the component has a strength of over 21,500 psi.

In another preferred embodiment, the component is heat cured, voltage cured, or both, and has a strength from 21,500-50,000 psi.

### Terminology

The terminology used herein is for the purpose of describing particular embodiments only and is not intended to limit the full scope of the claims. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

As used herein, the singular forms “a”, “an” and “the” are intended to include the plural forms as well, unless the context clearly indicates otherwise. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” etc.). Similarly, the terms “comprises” and/or “comprising,” when used in this specification, specify the presence of stated features, integers (or fractions thereof), steps, operations, elements, and/or components, but do not preclude the presence or addition of one or more other features, integers (or fractions thereof), steps, operations, elements, components, and/or groups thereof. As used in this document, the term “comprising” means “including, but not limited to.”

As used herein the term “and/or” includes any and all combinations of one or more of the associated listed items. It should be understood that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All ranges disclosed herein also encompass any and all possible subranges and combinations of subranges thereof unless expressly stated otherwise. Any listed range should be recognized as sufficiently describing and enabling the same range being broken down into at least equal subparts unless expressly stated otherwise. As will be understood by one skilled in the art, a range includes each individual member.

The embodiments herein, and/or the various features or advantageous details thereof, are explained more fully with reference to the non-limiting embodiments that are illustrated in the accompanying drawings and detailed in the following description. Descriptions of well-known components and processing techniques are omitted so as to not unnecessarily obscure the embodiments herein. Like numbers refer to like elements throughout.

The examples and/or embodiments described herein are intended merely to facilitate an understanding of structures, functions, and/or aspects of the embodiments, ways in which the embodiments may be practiced, and/or to further enable those skilled in the art to practice the embodiments herein. Similarly, methods and/or ways of using the embodiments described herein are provided by way of example only and not limitation. Specific uses described herein are not provided to the exclusion of other uses unless the context expressly states otherwise.

### Definitions

The term “ultra high performance concrete” refers to compositions made by the processes described here, and may further include the addition of aggregate to the cement paste.

The term “sand” refers to particles with a diameter of between 0.074 and 4.75 millimeters.

ISO 14688 grades sands as fine, medium, and coarse with ranges 0.063 mm to 0.2 mm. The most common constituent of sand, in inland continental settings and non-tropical coastal settings, is silica (silicon dioxide, or SiO₂), usually in the form of quartz.

The term “portland cement” refers to, in ASTM C150, hydraulic cement, cement that hardens by reacting with water and also forms a water-resistant product, produced by pulverizing clinkers which consist essentially of hydraulic calcium silicates, usually containing one or more of the forms of calcium sulfate as an inter ground addition. The term portland cement also refers to, in European Standard EN 197-1, a hydraulic material which shall consist of at least two-thirds by mass of calcium silicates, (3 CaO·SiO₂, and 2 CaO·SiO₂), the remainder consisting of aluminium- and iron-containing clinker phases and other compounds. The ratio of CaO to SiO₂ shall not be less than 2.0. The magnesium oxide content (MgO) shall not exceed 5.0% by mass.

The term “silica fume”, also known as microsilica, (CAS number 69012-64-2, EINECS number 273-761-1) refers to an (non-crystalline) polymorph of silicon dioxide, silica. It is an ultrafine powder collected as a by-product of the silicon and ferrosilicon alloy production and consists of spherical particles with an average particle diameter of 150 nm.

The term “silica flour” refers to a very finely divided, highly purified form (>98.0% silica) of crystalline silica that consists of particles of 10-100 μm in diameter.

The term “ceramic microspheres” refers in one non-limiting preferred embodiment to hard, thick-walled or solid, inert ceramic microspheres with a very fine particle size. In one non-limiting preferred embodiment, the ceramic particles have D50~4 microns average 50th percentile particle size, and D95 of 12 microns. In other preferred embodiments, the particles have very high compressive strength of 10,000-60,000 psi, or 70-400 MPa. In one non-limiting preferred embodiment the ceramic microspheres have a shape of hollow spheres with thick walls, they are composed of an silica-alumina ceramic, are non-soluble, and they have an average (50th percentile) D50 particle size of 4 microns. In one non-limiting preferred embodiment the particle size may encompass 1-24 micron. In one non-limiting preferred embodiment, they have a particle density of about 0.9 to about 2.4-2.5 gm/cc, and more preferably 2.1-2.5 gm/cc, and more preferably 2.5 gm/cc. In one non-limiting preferred embodiment, the silica-alumina composition includes a majority of silica dioxide and alumina oxide, with trace amounts of iron oxide, calcium oxide, magnesium oxide, sodium oxide, potassium oxide, carbon, and titanium oxide. More preferably, the composition may include SiO₂ (55-65%); Al₂O₃ (26-35%); Fe₂O₃ (0.2-1%); CaO (0.2-0.6%); MgO (1-2%); Na₂O, K₂O (0.5-4.0%); C (0.01-2.0%); TiO₂ (0.5-2%) 55-65%. The invention also contemplates the use, alone or in combination, of ceramic microspheres having a particle size ranging from 5-50 microns (50th percentile), or 1-160 microns up to the 95th percentile.

The term “cenospheres” refers to an optional microinclusion that is a thin-walled, hollow, lightweight, inert, sphere made largely of silica and alumina and filled with air or inert gas, typically produced as a coal combustion byproduct at thermal power plants. The color of cenospheres varies from gray to almost white and their density is about 0.4-0.8 g/cm3. Cenospheres are buoyant and float in aqueous mixtures and solutions due to their having a density of less than 1.0 g/cm3. Cenospheres have a compressive strength from 145-5000 psi, or 1-34 MPa.

The term “steel microfibers” refers to hair-like steel fibers that range from 10-20 mm long and about 0.2 mm in diameter, and are preferably on average 13 mm long and 0.2 mm in diameter. As used herein, the steel microfibers, in some embodiments contemplated within the scope of the invention, may include, without limitation, fibers ranging from 10-40 mm in length and 0.2-0.5 mm in diameter.

The term “microfiber” includes steel fiber, metal fiber, and chopped strand fiber, alone or in combination, ranging in size from about 10-840 micron diameter by 10-40 mm in length. In a preferred embodiment, the microfiber is steel fiber sized 0.2 mm×13 mm. In another preferred embodiment, the steel fiber is sized 0.2 mm×6 mm, especially useful for filling areas needing repair. In another preferred embodiment, the chopped strand microfibers range in size from 10-840 micron diameter (denier range from 400-7000) and 10-40 mm in length.

The term “chopped strand fiber” refers to microfibers of Basalt, Glass, Carbon, Synthetic polymer, Natural fiber, and multiple strand threads of one or more of the above.

The term “synthetic polymer fiber” refers to fibers made from Polyester (PE), including UHMWPE, aromatic polyester such as Vectran liquid-crystal polymer (LCP), Polyamides including Acrylic, Polyacrylonitrile, and Nylon, Aramids including Kevlar, Twaron, Nomex, and Technora, acrylics made from Polyester+polyamide 80/20 70/30, Polyolefins including polyethylene+polypropylene, Polyester+polyamide+polypropylene, Polyethylteraphthalate (PET), Polystyrene (PS), Acrylonitrile butadiene stryene (ABS), Polyvinyl chloride, Modacrylic, and strand combinations thereof.

The term “natural fiber” refers to fibers made from Cellulose, Bagasse, Bamboo, Cotton, Flax, Hemp, Jute, Pine, Silk, Sisal, Wood, Wool, and strand combinations thereof.

The term “microinclusions” refers to one or more of a secondary constituent comprised of a material in a specific form, wherein the material is selected from the group consisting of: cenospheres, metals, alloys, steel, synthetics, polymers, natural inorganics, minerals, glass, asbestos, carbon, cellulose, synthetic organics, natural organics, sisal, and combinations thereof, and the form of the material is selected from powder, grit, turnings, dust, flour, ribbon, shavings, nano- and micro-spheres, fibers, wire, microparticles, nanoparticles, complexes, aggregates, and mixtures thereof. Preferred microinclusions include cenospheres, silicon carbide powder, carbon nanotubes, and polymer or natural fibers or strands.

The term “admixture” or “admix” refers to chemicals and/or minerals that are used to improve the behavior of ultra high performance concrete under a variety of conditions. Chemical admixtures are used to improve the quality of ultra high performance concrete during mixing, transporting, placement and curing. Chemical admixtures can be categorized as follows: air entrainers; water reducers; set retarders; set accelerators; superplasticizers; and specialty admixtures, which include corrosion inhibitors, shrinkage control, alkali-silica reactivity inhibitors, and coloring. ASTM C494 specifies the requirements for seven chemical admixture types. They are: Type A: Water-reducing admixtures, Type B: Retarding admixtures, Type C: Accelerating admixtures, Type D: Water-reducing and retarding admixtures, Type E: Water-reducing and accelerating admixtures, Type F: Water-reducing, high range admixtures, Type G: Water-reducing, high range, and retarding admixtures. Exemplary high-range water-reducing admixtures (HRWRA), include CHRYSO Optima, CHRYSO Premia, GLENIUM® 3030 NS, Degussa Admixtures, Inc.; ADVA® 170 and ADVACAST® 500, W.R. Grace & Co., and PLASTOL, EUCON 37 and EUCON 1037, Euclid Chemical Co., in amounts approximately commensurate with the recommendations of the manufacturer.

The term “water reducer” refers to an admixture that is used to: (1) increase slump, (2) lower the water-cement ratio, or (3) reduce cement content. Water reducers range in ability to reduce water from low (achieve a minimum 5% water reduction) to mid-range (reduce water content by at least 8% and as much as 15%) to high-range (reduce water content from 12% to as much as 40%). The present invention does not require shrinkage reducing admix as the inventive composition is a non-shrinking paste.

The term “water reducer” means an additive that serves to reduce the amount of water required to produce an ultra high performance concrete of at least 5%. By way of example, water reducing agents based on lignosulfonic acids, carboxylic acid or treated carbohydrates can reduce the water requirements for the production of a ultra high performance concrete by approximately 10% to 15%. The term “water reducers” refers to compounds comprising a polyoxyalkyl chain and an amino-alkylene phosphonic group. Any of the processes and compositions herein may include an admixture comprising polycarboxylate, glutaral with 2-octyl-2H-isothiazol-3-one, 1,2-benzisothiazol-3(2H)-one with methylisothiazolinon, 2,2-iminodietanol with dodecyldimethylamine and formaldehyde, formaldehyde, 1,2-benzisothiazol-3(2H)-one, 5-chloro-2-methyl-2H-isothiazol-3-one with 2-methyl-2H-isothiazol-3-one, methylisothiazolinon, decyldimethylamine, and mixtures thereof.

The term “set accelerators” refers to compositions that work by accelerating cement hydration, which results in shortened setting times and increased early age strengths, particularly in cooler temperatures. They increase the rate of early strength development and reduce time required for curing and protection.

The term “superplasticizers” refers to compositions that can make a low-to-normal slump concrete into a high-slump flowing concrete which can be placed with little or no vibration. High-range water reducers fall into either ASTM C494 Type F or Type G classification. In either case, they can be used to produce very high slumps without segregation, an ideal situation where increased flowability is necessary due to congested reinforcement. Other applications and benefits of high-range water reducers include: difficult wall placements, narrow forms, sections with blockouts, penetrations, or embedded items, pumping high vertical distances, fast placement of concrete, and increased lift heights and free fall distances. The increased thinness of the ultra high performance concrete mix means that forms should be tight to prevent leakage even through small joints which can result in fins and discoloration. Type F superplasticizers: Added at the job site and keep ultra high performance concrete flowable for a short period of time. At some point, the concrete will lose slump quickly. Type G superplasticizers: Can be added either during batching or at the job site. This admixture will delay setting, but cause the ultra high performance concrete to be flowable for a longer period of time which could delay finishing. If haul times are particularly long, Type G can be added at the plant. However, if delivery is delayed too long, the effects can be diminished. Redosing is possible to regain the plasticity of the mix.

The expression “superplasticizer” or “superfluidifier” or “super water reducer” means a water reducer that reduces by more than 12%, the amount of water required for the realization of a ultra high performance concrete. Superplasticizers have generally been classified into four groups: sulfonated naphthalene formaldehyde condensate (or SNF, acronym for sulphonated naphthalene formaldehyde); sulphonated formaldehyde melamine condensate (or SMF, acronym for sulphonated melamine formaldehyde); modified lignosulphonates (or MLS, modified lignosulfonates); and others. More recent superplasticizers include polycarboxylate (“PC”) polymer dispersant compounds. Some of the PC superplasticizers may have a comb structure comprising at least one main chain and pendant grafts. Such superplasticizers are designated by the acronym PCP. For example, these superplasticizers carry ionic functions of carboxylic and/or sulphonic and/or phosphonic, preferably carboxylic, type at the level of the main chain and pendant links of the polyethylene glycol, polypropylene glycol, copolymer or other preferably water-soluble link type. By the term “polyalkylene oxide polycarboxylate” is meant polycarboxylate main chain comb copolymers having grafted side chains of polyalkylene oxide.

The term “corrosion inhibitor” refers to calcium nitrate Ca(NO3)2 or calcium nitrite Ca(NO₂)₂. Calcium nitrate/nitrite corrosion inhibitors prevent chloride induced corrosion of reinforcement in concrete. Calcium nitrate/nitrite inhibits corrosion of reinforcing steel initiated by both intruded and intermixed chloride. Preferably up to 3-4% calcium nitrate or calcium nitrite of cement by weight (ci/c weight %) seems sufficient to protect the reinforcing steel against corrosion due to intruded chlorides from the environment or intermixed chlorides from contaminated aggregate.

The term for defining the quantity of admix is know in the art to constitute ounces per 100 lbs of cementitious material. Thus, as a non-limiting example, where admix is listed as 50 ounces per 100 lbs, it refers to 50 ounces of admix per 100 lbs of cementitious material. Accordingly, the 100 lbs would not include the weight of aggregate, water, or fibers.

The term “mixing” refers to a process of combining dry ingredients to provide a heterogenous distribution of differing materials. Mixing may involve solid-solid mixing or mixing bulk solids with small amounts of liquid. Mixing includes a process of combining materials through tumbling, beating or stirring contents within a vessel, batch or continuous process, and storage silo mixing using live bins. Batch mixing may use drum mixers or pan mixers.

The present invention performs mixing for approximately 5-10 minutes and does not require high speed mixers to prepare the fiber reinforced UHPC cement-containing paste.

The term “microfiber reinforced UHPC paste” refers to the hydrated UHPC dry mix, including water, admixes, and microfiber.

The term “curing” refers to the process of applying heat and/or hydration, either humidity or submersion in water, to harden a poured (in situ) or formed (pre-cast) ultra high performance concrete article. The curing process increases the strength of the ultra high performance concrete. For example, curing can increase a ultra high performance concrete article from 17,000 psi to over 21,500 psi. Curing, in a non-limiting embodiment, can include placing in an environment of heat and optionally humidity or submersion at approximately 120-195 °F for about one to about four days. Cured UHPC is governed by ASTM C1856. Field curing of the inventive steel microfiber reinforced (SMR) ultra high performance concrete (UHPC) can, in a non-limiting embodiment, be performed at 150 °F for 2-4 days.

The term “psi” refers to pounds per square inch, and is synonymous with megapascal, abbreviated MPa. The conversion units between MPa and psi is that 1 MPa=145.0377 psi, and 1000 psi=6.894757 MPa.

The term “hydraulic binder” means, according to the present invention, a powdery material which, mixed with water, forms a paste which sets and hardens as a result of reactions and hydration processes, and which after curing, retains its strength and stability even under water.

The term “hydraulic composition” means any composition comprising a hydraulic binder. This is, for example, a ultra high performance concrete.

The term “ultra high performance concrete” or “UHPC”, as used herein, refers to the mixture of hydraulic binder (cement), fine aggregate (sand), optionally recycled glass, silica fume, silica flour, ceramic microspheres, water, two or more admixes, and microfibers. The present invention can achieve the desired microfiber reinforced UHPC components using any local sand and regular portland cement, without requiring the user to specify a particular type or composition of sand or cement.

The term “setting” means according to the present invention the transition to the solid state by chemical reaction of hydration of the binder. The setting is usually followed by the hardening period.

The term “hardening” means according to the present invention the acquisition of the mechanical properties of a hydraulic binder, after the end of setting.

The term “SiC” refers to an optional microinclusion that is silicon carbide. Industrial production of SiC can be achieved by high temperature treatment of organic materials such as agricultural waste husks.

The term “CNT” refers to an optional microinclusion that is carbon nanotubes. In a preferred non-limiting embodiment, the CNTs have a diameter from 20-40 nm and a length from 0.5-40 nm.

The term “silica” refers to silicon dioxide.

### Recycled Glass Powder

Glass powder acts as a slow pozzolan. Recycled glass powder (GP) is available from subjecting glass in glass recycling processes to specialty grinding. Recycled GP functions as a partial cement replacement. The invention contemplates recycled GP 2.5-6.0 micron as a cement replacement. In another preferred embodiment, the recycled GP as a cement replacement from 5-15 weight %. In another preferred embodiment, the recycled GP as a cement replacement from 5-25 weight %. In another preferred embodiment, the recycled GP as a cement replacement from 2-15 weight %.

### Recycled Glass Powder Milling

Glass is one of the more difficult materials to process as it has a high hardness (Mohs hardness of ~5.5 to 7) and sharp edges upon fracture. Durable, field-proven, equipment and techniques are required for successful glass grinding, especially for ultra-fine milling requirements. For high quality, ultra-fine, glass powder production, the invention contemplates recycled glass powder produced from a specialty ball mill, such as the Alpine Super-Orion Ball Mill in circuit with an Air Classifier available from Hosokawa Micron Powder Systems. For preparing recycled glass powder applications, the ball mill will typically be constructed with hardened, high chrome, steel media and ball mill lining. A second option would be Aluminum Oxide media and lining.

For a second component of recycled glass powder 20-200 micron, the invention contemplates using recycled glass powder obtained using an air classifier, such as that available from Hosokawa, the Hosokawa Alpine Stratoplex (ASP) which is used for a cut point (top size) of 20 to 200 microns, or the Hosokawa Alpine Turboplex (ATP) air classifier is used for super fine applications with a cut point (top size) of 5 to 50 microns, with single and multi-wheel options. Both classifiers are made with Aluminum Oxide classifier wheels, with an interior Aluminum Oxide tiling. This allows for fine grinding and durability.

### Recycled Glass Powder Size

Preferably, the recycled glass powder comprises an average cut-point particle size (D50) of about 2.5-6.0 microns. In another preferred embodiment, the recycled glass powder has an average particle size (D50) of about 4.0 microns. In another preferred embodiment, the recycled glass powder has an average particle size (D50) of about 6.0 micron, such as that available from Vitro Minerals CS 400 at www.matweb.com. In another preferred embodiment, the invention includes a second component of recycled glass powder having has an average particle size (D50) of about 5-50 microns, such as that available from Mo-Sci corporation, e.g. 10 micron glass catalog GL0804P. In another preferred embodiment, the second component of recycled glass powder comprises has an average particle size (D50) of about 20-200 microns. Glass powder is available through industrial suppliers such as Ferro corporation.

### Recycled Glass Powder Wire Mesh

For the second component of recycled glass powder, wire mesh having a grid of 50×50 per inch can sort and separate glass powder at 200 micron. Wire mesh having a grid of 110×110 per inch can sort and separate glass powder at about 100 micron. Wire mesh having a grid of 250×250 per inch can sort and separate glass powder at 40 micron. Wire mesh having a grid of 400×400 per inch can sort and separate glass powder at 25 micron. Wire mesh having a grid of 635×635 per inch can sort and separate glass powder at 20 micron. Wire mesh may be obtained at a suitable mesh supplier such as Hole Metals at www.holemetals.com.

Recycled glass powder has major oxide components comprising SiO₂, Na₂O, and CaO. In a preferred embodiment, the invention may contemplate recycled GP having weight % chemical composition comprising about: Na₂O 10.13%, MgO 1.17%, Al₂O₃ 2.51%, SiO₂ 69.43%, P₂O₅ 0.15%, SO₃ 0.84%, K₂O 1.15%, CaO 11.93%, and Other 1.38%.

### EXAMPLES

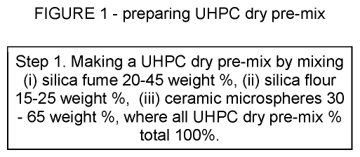

Referring now to FIG. 1 the inventive process includes in one non-limiting preferred embodiment a process for preparing UHPC dry pre-mix comprising the step making a UHPC dry pre-mix by mixing (i) silica fume 20-45 weight %, (ii) silica flour 15-25 weight %, and (iii) ceramic microspheres 30-65 weight %, where all UHPC dry pre-mix % total 100%.

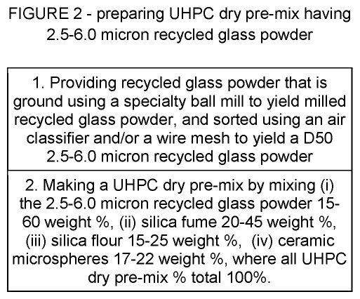

Referring to FIG. 2 the inventive process includes in one non-limiting preferred embodiment a process for preparing UHPC dry pre-mix having 2.5-6.0 micron recycled glass powder by mixing (i) silica fume 20-45 weight %, (ii) silica flour 15-25 weight %, (iii) ceramic microspheres 17-22 weight %, and 2.5-6.0 micron recycled glass powder 15-60 weight %, where all UHPC dry pre-mix % total 100%.

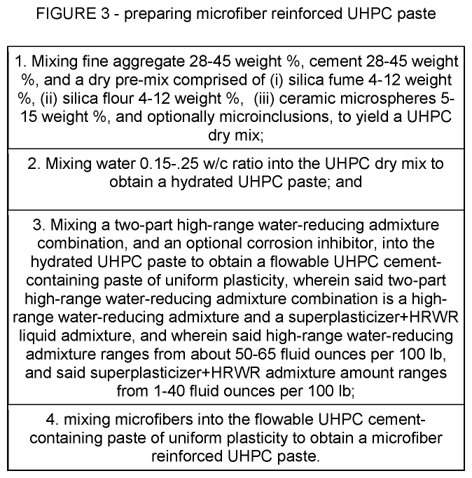

Referring now to FIG. 3 the inventive process includes in one non-limiting preferred embodiment a process for preparing micro-fiber reinforced UHPC paste comprising the steps: 1. Mixing fine aggregate 28-45 weight %, cement 28-45 weight %, and a dry pre-mix comprised of (i) silica fume 4-12 weight %, (ii) silica flour 4-12 weight %, (iii) ceramic microspheres 5-15 weight %, and optionally microinclusions, to yield a UHPC dry mix; 2. Mixing water 0.15-0.25 w/c ratio into the UHPC dry mix to obtain a hydrated UHPC paste; and 3. Mixing a two-part high-range water-reducing admixture combination, and an optional corrosion inhibitor, into the hydrated UHPC paste to obtain a flowable UHPC cement-containing paste of uniform plasticity, wherein said two-part high-range water-reducing admixture combination is a high-range water-reducing admixture and a superplasticizer+HRWR liquid admixture, and wherein said high-range water-reducing admixture ranges from about 50-65 fluid ounces per 100 lb, and said superplasticizer+HRWR admixture amount ranges from 1-40 fluid ounces per 100 lb; and 4. mixing microfibers into the flowable UHPC cement-containing paste of uniform plasticity to obtain a microfiber reinforced UHPC paste.

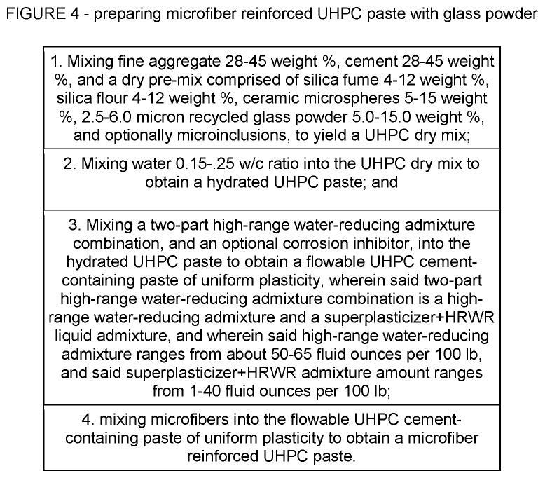

Referring now to FIG. 4 the inventive process includes in one non-limiting preferred embodiment a process for preparing micro-fiber reinforced UHPC paste with glass powder. The process comprises the steps: 1. Mixing fine aggregate 28-45 weight %, cement 28-45 weight %, and a dry pre-mix comprised of silica fume 4-12 weight %, silica flour 4-12 weight %, ceramic microspheres 5-15 weight %, 2.5-6.0 micron recycled glass powder 5.0-15.0 weight %, and optionally microinclusions, to yield a UHPC dry mix; 2. Mixing water 0.15-0.25 w/c ratio into the UHPC dry mix to obtain a hydrated UHPC paste; and 3. Mixing a two-part high-range water-reducing admixture combination, and an optional corrosion inhibitor, into the hydrated UHPC paste to obtain a flowable UHPC cement-containing paste of uniform plasticity, wherein said two-part high-range water-reducing admixture combination is a high-range water-reducing admixture and a superplasticizer+HRWR liquid admixture, and wherein said high-range water-reducing admixture ranges from about 50-65 fluid ounces per 100 lb, and said superplasticizer+HRWR admixture amount ranges from 1-40 fluid ounces per 100 lb; 4. mixing microfibers into the flowable UHPC cement-containing paste of uniform plasticity to obtain a microfiber reinforced UHPC paste.

### Example—Preparing UHPC Dry Pre-Mix Having 2.5-6.0 Micron Recycled Glass Powder

In another non-limiting preferred embodiment, the inventive process includes: Step 1. Providing recycled glass powder that is recycled glass ground using a specialty ball mill to yield milled recycled glass powder, and sorted to yield a 2.5-6.0 micron recycled glass powder; Step 2. Making a UHPC dry pre-mix by mixing (i) the 2.5-6.0 micron recycled glass powder 17-18.5 weight %, (ii) silica fume 36-41 weight %, (iii) silica flour 23-24 weight %, (iv) ceramic microspheres 17-22 weight %, where all % total 100%.

### Example—Preparing Multi-Fiber Reinforced UHPC Paste

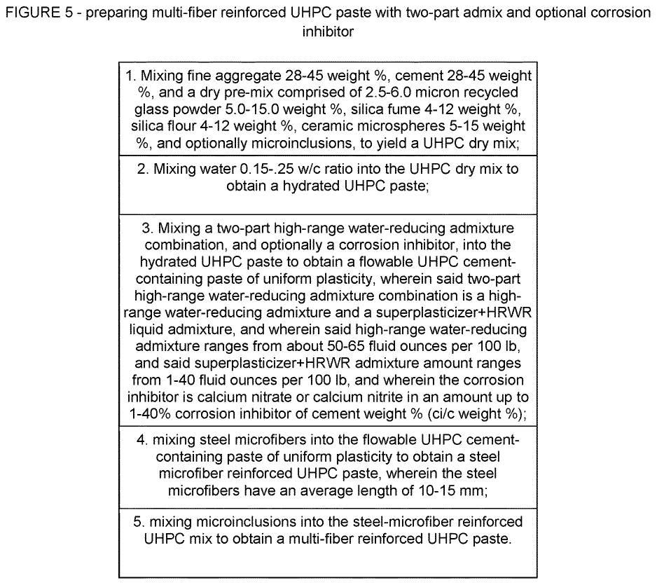

Referring now to FIG. 5, the inventive process includes in one non-limiting preferred embodiment: Step 1. Mixing fine aggregate 28-45 weight %, cement 28-45 weight %, and a dry pre-mix comprised of 2.5-6.0 micron recycled glass powder 5-15 weight %, (ii) silica fume 4-12 weight %, (iii) silica flour 4-12 weight %, (iv) ceramic microspheres 5-15 weight %, and optionally microinclusions, to yield a UHPC dry mix; Step 2. Mixing water 0.15-0.25 w/c ratio into the UHPC dry mix to obtain a hydrated UHPC paste; Step 3. Mixing a two-part high-range water-reducing admixture combination, and optionally a corrosion inhibitor, into the hydrated UHPC paste to obtain a flowable UHPC cement-containing paste of uniform plasticity, wherein said two-part high-range water-reducing admixture combination is a high-range water-reducing admixture and a superplasticizer+HRWR liquid admixture, and wherein said high-range water-reducing admixture ranges from about 50-65 fluid ounces per 100 lb of said resultant cement-containing paste, and said superplasticizer+HRWR admixture amount ranges from 1-40 fluid ounces per 100 lb, and wherein the corrosion inhibitor is calcium nitrate or calcium nitrite in an amount up to 3-4% corrosion inhibitor of cement weight % (ci/c weight %); Step 4. mixing steel microfibers into the flowable UHPC cement-containing paste of uniform plasticity to obtain a steel microfiber reinforced UHPC paste, wherein the steel microfibers have an average length of 10-15 mm; and Step 5. mixing microinclusions into the steel-microfiber reinforced UHPC mix to obtain a multi-fiber reinforced UHPC paste.

### Example—Preparing a UHPC Component in a Form

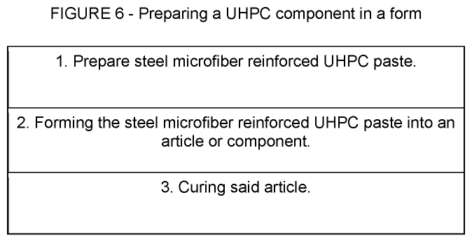

Referring now to FIG. 6, the inventive process includes in one non-limiting preferred embodiment: Step 1. Prepare steel microfiber reinforced UHPC paste by: Mixing fine aggregate 28-45 weight %, cement 28-45 weight %, and a dry pre-mix comprised of 2.5-6.0 micron recycled glass powder 5-15 weight %, (ii) silica fume 4-12 weight %, (iii) silica flour 4-12 weight %, (iv) ceramic microspheres 5-15 weight %, and optionally microinclusions, to yield a UHPC dry mix; Mixing water 0.15-0.25 w/c ratio into the UHPC dry mix to obtain a hydrated UHPC paste; Mixing a high-range water-reducing admixture and a superplasticizer+HRWR admixture, and an optional corrosion inhibitor, into the hydrated UHPC paste to obtain a flowable UHPC cement-containing paste of uniform plasticity; and mixing steel microfibers into the flowable UHPC cement-containing paste of uniform plasticity to obtain a steel microfiber reinforced UHPC paste. Step 2. Forming the steel microfiber reinforced UHPC paste into an article or component. And Step 3. Curing said article.

### Example—Preparing a Cured UHPC Component

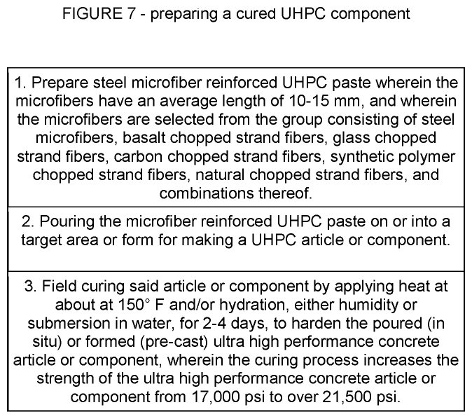

Referring now to FIG. 7, the inventive process includes in one non-limiting preferred embodiment: Step 1. Prepare steel microfiber reinforced UHPC paste by: Mixing fine aggregate 28-45 weight %, cement 28-45 weight %, and a dry pre-mix comprised of 2.5-6.0 micron recycled glass powder 5-15 weight %, (ii) silica fume 4-12 weight %, (iii) silica flour 4-12 weight %, (iv) ceramic microspheres 5-15 weight %, and optionally microinclusions, to yield a UHPC dry mix; Mixing water 0.15-0.25 w/c ratio into the UHPC dry mix to obtain a hydrated UHPC paste; Mixing a high-range water-reducing admixture and a superplasticizer+HRWR admixture, and an optional corrosion inhibitor, into the hydrated UHPC paste to obtain a flowable UHPC cement-containing paste of uniform plasticity; and mixing microfibers into the flowable UHPC cement-containing paste of uniform plasticity to obtain a microfiber reinforced UHPC paste, wherein the microfibers have an average length of 10-15 mm, and wherein the microfibers are selected from the group consisting of steel microfibers, basalt chopped strand fibers, glass chopped strand fibers, carbon chopped strand fibers, synthetic polymer chopped strand fibers, natural chopped strand fibers, and combinations thereof. Step 2. Pouring the microfiber reinforced UHPC paste on or into a target area or form for making a UHPC article or component. Step 3. Field curing said article or component by applying heat at about at 150 °F and/or hydration, either humidity or submersion in water, for 2-4 days, to harden the poured (in situ) or formed (pre-cast) ultra high performance concrete article or component, wherein the curing process increases the strength of the ultra high performance concrete article or component from 17,000 psi to over 21,500 psi.

### Example—Preparing a Microfiber Reinforced UHPC Paste

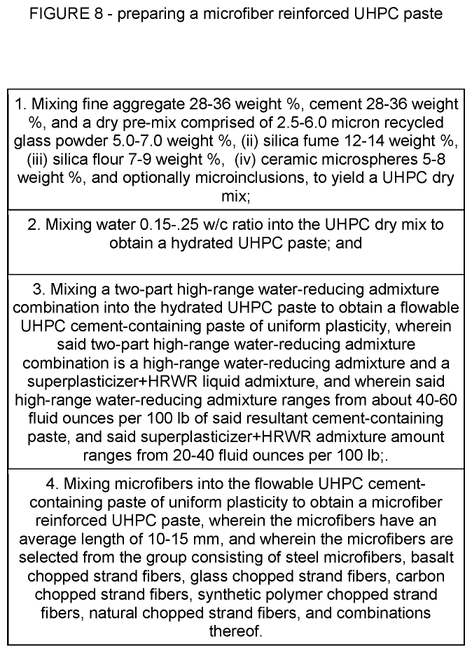

Referring now to FIG. 8, the inventive process includes in one non-limiting preferred embodiment: Step 1. Mixing fine aggregate 28-45 weight %, cement 28-45 weight %, and a dry pre-mix comprised of 2.5-6.0 micron recycled glass powder 5-15 weight %, (ii) silica fume 4-12 weight %, (iii) silica flour 4-12 weight %, (iv) ceramic microspheres 5-15 weight %, and optionally microinclusions, to yield a UHPC dry mix; Step 2. Mixing water 0.15-0.25 w/c ratio into the UHPC dry mix to obtain a hydrated UHPC paste; and Step 3. Mixing a two-part high-range water-reducing admixture combination into the hydrated UHPC paste to obtain a flowable UHPC cement-containing paste of uniform plasticity, wherein said two-part high-range water-reducing admixture combination is a high-range water-reducing admixture and a superplasticizer+HRWR liquid admixture, and wherein said high-range water-reducing admixture ranges from about 50-65 fluid ounces per 100 lb of said resultant cement-containing paste, and said superplasticizer+HRWR admixture amount ranges from 1-40 fluid ounces per 100 lb.

4. Mixing microfibers into the flowable UHPC cement-containing paste of uniform plasticity to obtain a microfiber reinforced UHPC paste, wherein the microfibers have an average length of 10-15 mm, and wherein the microfibers are selected from the group consisting of steel microfibers, basalt chopped strand fibers, glass chopped strand fibers, carbon chopped strand fibers, synthetic polymer chopped strand fibers, natural chopped strand fibers, and combinations thereof.

### Example—Preparing a UHPC Component Having Microinclusions

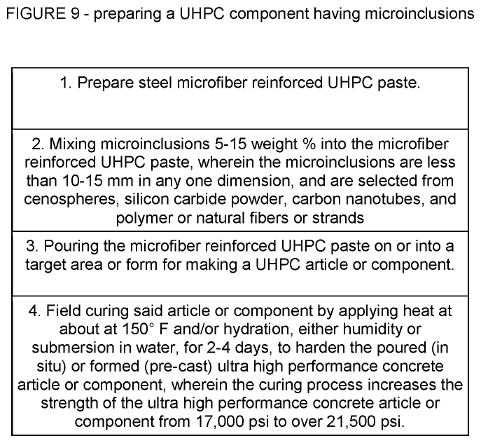

Referring now to FIG. 9, the inventive process includes in one non-limiting preferred embodiment: Step 1. Prepare steel microfiber reinforced UHPC paste by: Mixing fine aggregate 28-45 weight %, cement 28-45 weight %, and a dry pre-mix comprised of 2.5-6.0 micron recycled glass powder 5-15 weight %, (ii) silica fume 4-12 weight %, (iii) silica flour 4-12 weight %, (iv) ceramic microspheres 5-15 weight %, and optionally microinclusions, to yield a UHPC dry mix; Mixing water 0.15-0.25 w/c ratio into the UHPC dry mix to obtain a hydrated UHPC paste; Mixing a high-range water-reducing admixture and a superplasticizer+HRWR admixture, and an optional corrosion inhibitor, into the hydrated UHPC paste to obtain a flowable UHPC cement-containing paste of uniform plasticity; and mixing microfibers into the flowable UHPC cement-containing paste of uniform plasticity to obtain a microfiber reinforced UHPC paste, wherein the microfibers have an average length of 10-15 mm, and wherein the microfibers are selected from the group consisting of steel microfibers, basalt chopped strand fibers, glass chopped strand fibers, carbon chopped strand fibers, synthetic polymer chopped strand fibers, natural chopped strand fibers, and combinations thereof. Step 2. Mixing microinclusions 5-15 weight % into the microfiber reinforced UHPC paste, wherein the microinclusions are less than 10-15 mm in any one dimension, and are selected from cenospheres, silicon carbide powder, carbon nanotubes, and polymer or natural fibers or strands. Step 3. Pouring the microfiber reinforced UHPC paste on or into a target area or form for making a UHPC article or component. Step 4. Field curing said article or component by applying heat at about at 150 °F and/or hydration, either humidity or submersion in water, for 2-4 days, to harden the poured (in situ) or formed (pre-cast) ultra high performance concrete article or component, wherein the curing process increases the strength of the ultra high performance concrete article or component from 17,000 psi to over 21,500 psi.

### Example—Component and Articles Made Using the Inventive Processes

The inventive process includes in non-limiting preferred embodiments, the making of UHPC components and articles which may include wherein the cement structure is a component selected from the group consisting of: a transportation and highway component, a ballistic component, a construction component, a utility component, and a marine component.

### Example—Transportation and Highway Component and Articles

The inventive process includes in non-limiting preferred embodiments, the making of a UHPC component and article which includes in a non-limiting embodiment, an overlay, decking, a joint fill, a beam end-cap, a plate, a channel, a pipe, a tube, an I-beam piling/section, an H-beam piling component, a WF-section, a smooth column, a fluted column, a connector, a precast highway slab, a bridge span, a precast railroad tie, a precast parking block, a precast jersey barrier, a street curb, a sidewalk, a driveway, a drive apron, a guard rail, a bollard

### Example—Ballistic Component and Articles Made

The inventive process includes in non-limiting preferred embodiments, the making of a UHPC component and article which includes in a non-limiting embodiment, vehicle up-armoring, ballistic armor for walls and doors, an armored roofing tile, a ballistic panel for a building, a ballistic panel for a ship, a ballistic panel for an aircraft, a ballistic panel for a truck, and a ballistic panel for a passenger vehicle, a ballistic floor tile, a blast-resistant panel, a man-portable panel, a thin armor panel, a forced entry resistant structural element, a hurricane and tornado resistant structural element, and combinations thereof.

### Example—Construction Component and Articles Made

The inventive process includes in non-limiting preferred embodiments, the making of a UHPC component and article which includes in a non-limiting embodiment, a wall, a slab, a truss, a joist, a rafter, a support gusset, a footer, an underflooring, a warehouse slab, a silo, a loading dock, a concrete block, a brick, a panel, a roofing tile, a siding plank, a mounting pad, a paver, a post and pole anchor block, a floor tile, a kitchen tile, a bath tile, a kitchen and bath countertop, a laboratory bench top, a fireplace liner, a veneer, a decking plank, a post, a support, a planter, a paver, a stepping stone, a bench, a fireplace, a gutter, and a drainage tile.

### Example—Utility Component and Articles Made

The inventive process includes in non-limiting preferred embodiments, the making of a UHPC component and article which includes in a non-limiting embodiment, an in situ poured water conduit and structure, a precast water conduit, in situ poured sewer pipe and structure, a precast sewage pipe, an in situ poured water or sewer connector, a precast water or sewer connector, a mounting pad, a post and pole anchor block, a holding pond, a spillway, a security barrier, a traffic diversion structure, a gatehouse, a solar panel pad, a wind turbine slab, a wind turbine tower, a smokestack, a refractory furnace brick, an oil and gas well cementing for casings, a storage tank pad, a drilling slab, a pump jack slab, a pipeline footer, a spillway for oil and gas, a holding pond for oil and gas, a protective utility box, a security wall, an offshore rig structural component, a power transmission tower, a power substation security wall, a water control dam, an aqueduct, a electrical utility pole and tower, an electrical utility (junction) box, a natural gas utility box, a telecommunication utility pole, a telecommunication utility (junction) box, a telecommunication (telephone) pole, and mobile cell phone tower.

### Example—Marine Component and Articles Made

The inventive process includes in non-limiting preferred embodiments, the making of a UHPC component and article which includes in a non-limiting embodiment, a seawall, a sea barrier block and form, a waterway bridge piling, a waterway bridge span, column, and decking, a building piling, span, column and slab, an undersea piling, an undersea mounting pad, an undersea cofferdam having a cement base and a UHPC cap layer, a harbor dock, a marina piling, a dock, a navigation structure, a lighthouse, a waterway navigation light and structure, a boat launch ramp, a reservoir liner and wall.

### Example—Casting

Any of the methods of making ultra high performance concrete forms may be made by techniques selected from the group consisting of: spin casting, extrusion molding, pressure molding, pouring into forms, and combinations thereof.

### Example—Curing

Any of the methods of making ultra high performance concrete forms wherein said composition component is cured. In a non-limiting preferred embodiment, the hydrated but not fully cured, microfiber UHPC-based paste is heated. In select embodiments of the present invention, curing can increase a ultra high performance concrete article from 17,000 psi to over 21,500 psi. In another non-limiting embodiment, the article/component is cured by: placing in an environment of heat and optionally humidity or submersion at approximately 120-195 °F for about one to about four days. Cured UHPC is governed by ASTM C1856. Field curing of the inventive steel microfiber reinforced (SMR) ultra high performance concrete (UHPC) can, in a non-limiting embodiment, be performed at 150 °F for 2-4 days. Longer duration heat curing can increase strength from 21,500 psi up to 50,000 psi.

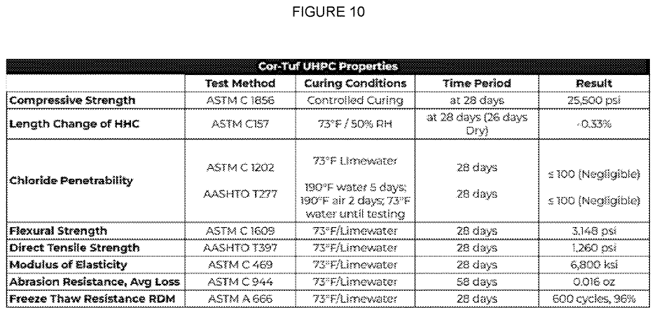

FIG. 10 is a table showing CorTuf microfiber reinforced UHPC properties, including ASTM testing methods, curing conditions, time periods, and strength results. FIG. 8 shows the length of change, chloride penetrability, flexural strength, direct tensile strength, modulus of elasticity, abrasion resistance, and freeze-thaw resistance, of the UHPC product.

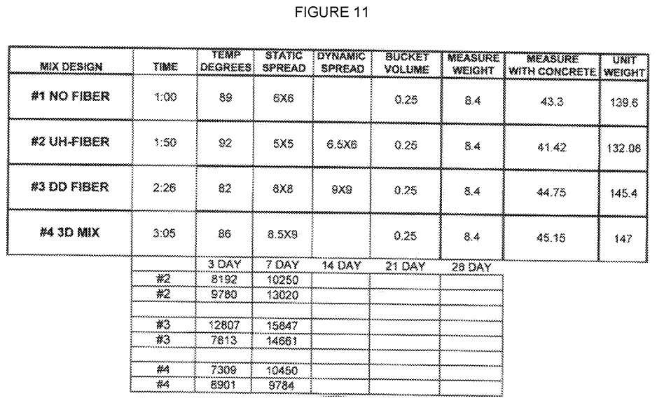

FIG. 11 is a table showing psi strength after 3-day and 7-day curing periods for fiber mix designs compared to no fiber mixes, “UH-FIBER”, “DD FIBER”, and “3D mix”.

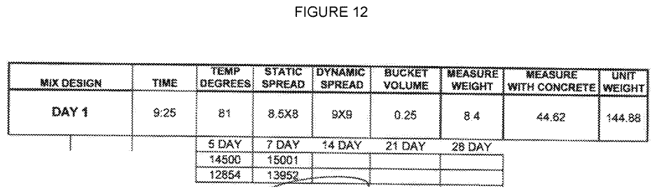

FIG. 12 is a table showing psi strength after 5-day and 7-day curing periods for a mix design “Day 1”.

### COMPARATIVE EXAMPLES

| Type of | | | |
|---|---|---|---|
| composition | psi | invention | |
| Mortar | 1200 | | |
| Concrete | 3000-4000 | 17,000-21,500+ | |
| Failures | psi | invention | |
| Wrong admix | 3000-4000 | Correct admix | 17,000-21,500+ |
| Lacking steel | 3000 | incl. Steel | 17,000-21,500+ |
| microfibers | | microfibers | |
| Large macro | 4000 | macroinclusions | 17,000-21,500+ |
| fibers | | | |
| Wrong sand, | <3000-4000 | clean, sized sand | 17,000-21,500+ |
| impurities | | | |
| Mixing admix | 4000 | correct process | 17,000-21,500+ |
| before water | | | |
| Mix all in one | clumps, | correct sequence | 17,000-21,500+ |
| Amorphous | | not amorphous | |
| Lacking CNT | 3000-4000 | incl. CNT | 17,000-21,500+ |
| Not curing | 3000-4000 | incl. | 17,000-21,500+ |
| Using chloride | <3000 (oxidizes) | | — |
| admix | | | |
| Large aggregate | 3000-4000 large | | — |
| | pores, too porous | | |

### Example—Molds and Forms

In select non-limiting preferred embodiments of the present invention, the microfiber UHPC-based paste is placed in forms or molds to hydrate (harden). In select embodiments of the present invention, the forming procedure depends on the rheology of the final cement-based paste. Flowable cement-based pastes are placed or poured into forms that contain the cement-based paste until it hydrates.

In select embodiments of the present invention, fluid microfiber UHPC-based paste may be vibrated by placing forms filled with microfiber UHPC-based paste on an external vibrating table and vibrating the forms and microfiber UHPC-based paste as a unit, or by inserting internal vibrators into the microfiber UHPC-based paste and vibrating until it is consolidated. Vibration frees entrapped air voids from the microfiber UHPC-based paste and consolidates solid constituents into a tightly packed configuration.

In select embodiments of the present invention, mixtures of the microfiber UHPC-based paste are shaped by pressure forming, molding, extrusion molding, or spin casting. In select embodiments of the present invention, pressure molding comprises rolling or pressing microfiber UHPC-based paste into a prepared mold or pressing microfiber UHPC-based paste to a given thickness as in the case of making plates or tiles. In select embodiments of the present invention, placing microfiber UHPC-based paste into an extruder and applying pressure to force it through the die yields a final molded shape. Extruded product may need to be supported until it hardens to prevent it from changing shape. In select embodiments of the present invention, spin casting involves placing microfiber UHPC-based paste along the longitudinal axis of the inside of a form/mold and spinning the form/mold at high speed to distribute the microfiber UHPC-based paste evenly over the inside of the form/mold with the centrifugal force created by the spinning.

In select embodiments of the present invention, the formed/molded, extruded or spun-cast microfiber UHPC-based paste is left in the form/mold or supported in the extruded or spun-cast shape until it has hydrated. This is normally 24 hours, but may be longer depending on the amount of the HRWRA specified for the formulation. In select embodiments of the present invention, product is not removed from the form/mold until it has achieved a stiffness that resists deformation under moderate force, such as thumb pressure.

As shown, select embodiments of the present invention provide a composition that is both strong and tough for fabricating superior building components. These superior components may be made in any shape through form casting while conventional structural shapes may be made by either mold extrusion or spin-casting.

### Example—Use as Armor

Select embodiments of the present invention are suitable for fabricating inexpensive structural panels, such as thin armor panels that may be used for vehicles as well as fixed structures. Structural armor panels may be formed or extruded to a thickness heretofore impractical because of the improved toughness and strength of embodiments of the present invention. For example, panels may be produced in size and thickness to accommodate man-portability. These man-portable panels may be configured for attaching to a structural framework to resist penetration of small arms fire and mitigate blast and fragmentation effects.

An embodiment of the present invention, configured appropriately, offers an inexpensive solution for force protection in addition to man-portable products. For the military and government applications: very high performance composition incorporated in inexpensive ballistic armor; light weight structural shapes such as plates, channels, pipes, tubes, I- and WF-sections; connectors; protective construction; blast-resistant panels; fragmenting munitions protection; vehicle up-armoring; forced entry resistant structural elements and the like.

### Example—Commercial Construction

For commercial or residential construction, the ultra high performance concrete is used to manufacture components are selected from the group consisting of: bridge and road components, armored components, building construction components, exterior building components, interior building components, landscape components, water and sewer components, marine construction components, industrial site components, oil and gas components, and utility components.

In preferred embodiments, the bridge and transportation components include without limitation overlays, joint fills, beam end-caps, plates, channels, pipes, tubes, I-beam sections, H-beam components, WF-sections, smooth columns, fluted columns, connectors, precast highway slabs, precast railroad ties, precast parking blocks, precast jersey barriers, street curbs, sidewalks, driveways, drive aprons, guard rails, and bollards.

In preferred embodiments, the armored components include without limitation vehicle up-armoring, ballistic armor for walls and doors, armored roofing tiles, ballistic panels for buildings, ships, aircraft, trucks, and passenger vehicles, ballistic floor tiles, blast-resistant panels, man-portable panels, thin armor panels, and forced entry resistant structural elements.

In preferred embodiments, the building construction components include without limitation walls, plates, channels, pipes, tubes, I-beam sections, H-beam components, WF-sections, columns, connectors, slabs, trusses, joists, rafters, support gussets, footers, underflooring, concrete blocks, and bricks.

In preferred embodiments, the exterior building components include without limitation panels, roofing tiles, siding, mounting pads, pavers, and post and pole anchor blocks.

In preferred embodiments, interior building components include without limitation floor tiles, kitchen tiles, bath tiles, kitchen and bath countertops, laboratory bench tops, fireplace liners, and veneers.

In preferred embodiments, landscape components include without limitation decking, posts, supports, joists, footers, planters, pavers, stepping stones, benches, fireplaces, gutters, and drainage tiles.

In preferred embodiments, water and sewer components include without limitation in situ water conduit and structures, precast water conduit, in situ sewer pipes and structures, precast sewage pipes, in situ poured connectors, and precast connectors.

In preferred embodiments, the marine construction components include without limitation seawalls, sea barrier blocks and forms, waterway bridge pilings, waterway bridge spans, columns, and decking, building pilings, spans, columns and slabs, undersea pilings, undersea mounting pads, undersea coffer dams having a cement base and a UHPC cap layer, harbor docks, marina pilings, docks, and navigation structures, lighthouses, waterway navigation lights and structures, boat launch ramps, and reservoir liners and walls.

In preferred embodiments, industrial site components include without limitation mounting pads, post and pole anchor blocks, warehouse slabs, holding ponds, spillways, silos, loading docks, security barriers, traffic diversion structures, gatehouses, solar panel pads, wind turbine slabs, wind turbine towers, smokestacks, and refractory furnace bricks.

In preferred embodiments, the oil and gas components include without limitation oil and gas well cementing for casings, storage tank pads, drilling slabs, pump jack slabs, pipeline footers, spillways, holding ponds, protective utility boxes, security walls, and offshore rig structural components.

In preferred embodiments, the utility components include without limitation power transmission towers, power substation security walls, water control dams and aquaducts, electrical utility poles and towers, electrical utility (junction) boxes, natural gas utility boxes, telecommunication utility poles, telecommunication utility (junction) boxes, telecommunication (telephone) poles, and mobile cell phone towers.

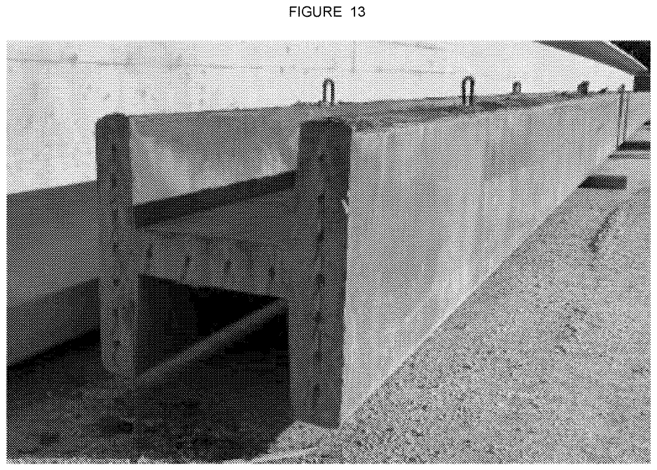

FIG. 13 is an image of an H pile constructed using the steel microfiber reinforced ultra high performance concrete herein. FIG. 13 shows that pre-cast forms can be used for many types of construction projects.

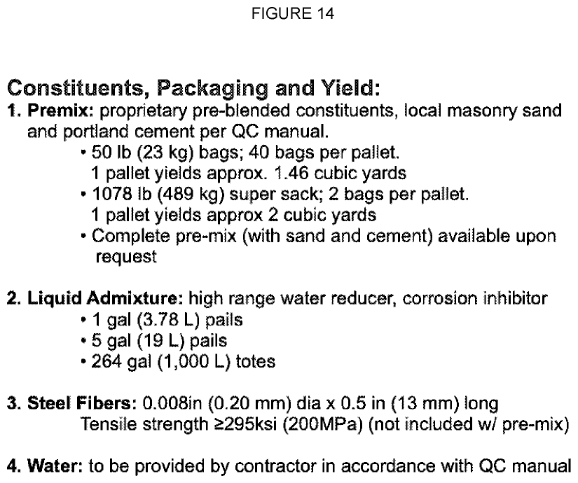

FIG. 14 is a table of microfiber reinforced UHPC constituents, packaging, and yield. FIG. 14 shows that local cement and local sand are added to the dry pre-mix of recycled glass powder, silica fume, silica flour, ceramic microspheres, and optional microinclusions. Then water, admix and steel fibers, in one non-limiting preferred embodiment are mixed to create a microfiber reinforced UHPC cement-containing paste.

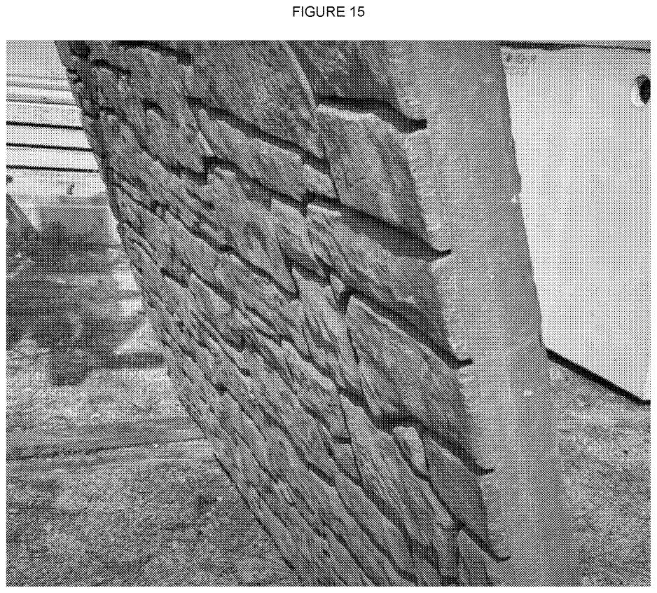

FIG. 15 is an image of a precast form (wall) made from a unitary pour of microfiber reinforced UHPC. FIG. 15 shows that the product provides a consistency that permits use in detailed decorative construction articles.

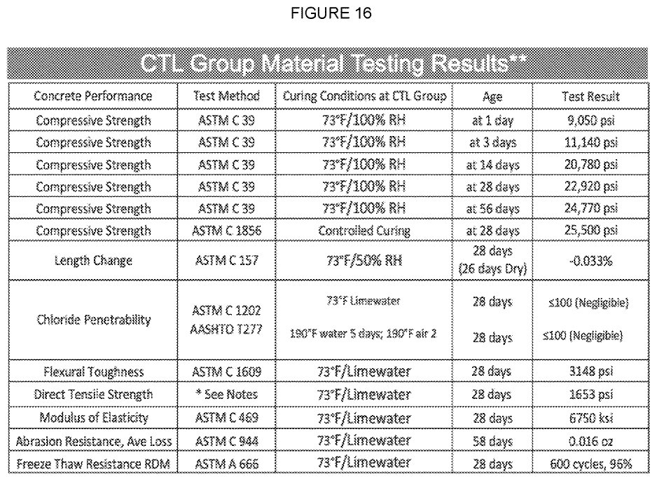

FIG. 16 is a table of microfiber reinforced UHPC testing results. FIG. 16 shows a column of concrete performance, ASTM testing methods, curing conditions, curing age, and psi test results.

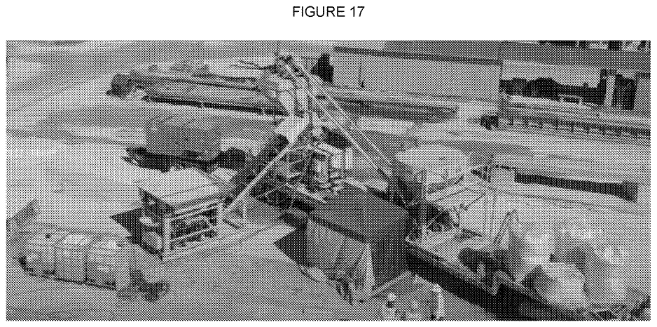

FIG. 17 is an image of a mobile processing plant. FIG. 17 shows a mobile trailer having hopper bins connected by feeders/augers for sand, cement, ultra high performance concrete additive, and microfibers, as well as containers for dispensing admix and water. Super sacks containing specific components are loaded into the appropriate hopper and transported to a central mixing container. All of the required components of the mobile processing plant can be transported to a specific location reducing the need to mix offsite and transport ultra high performance concrete to the pour location.

### Example—UHPC White Concrete

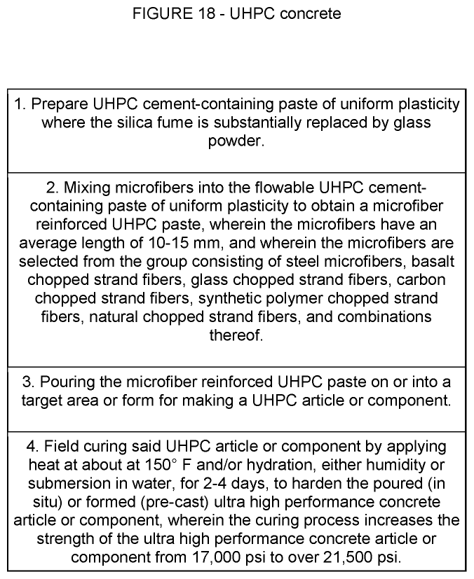

FIG. 18 illustrates in a non-limiting preferred embodiment, that the invention includes articles and components manufactured having a white color by replacement of most or all of the silica fume, which is a dark material that imparts a dark color to the concrete, with the 2.5-6.0 micron recycled glass powder. According, the process for making white UHPC comprises: Step 1. Mixing fine aggregate 28-45 weight %, cement 28-45 weight %, and a dry pre-mix comprised of 2.5-6.0 micron recycled glass powder 12.0-14.0 weight %, (ii) silica fume 0-2 weight %, (iii) silica flour 4-12 weight %, (iv) ceramic microspheres 5-60 weight %, and optionally microinclusions, all weight % equals 100%, to yield a UHPC dry mix; Step 2. Mixing water 0.15-0.25 w/c ratio into the UHPC dry mix to obtain a hydrated UHPC paste; and Step 3. Mixing a two-part high-range water-reducing admixture combination, with an optional corrosion inhibitor, into the hydrated UHPC paste to obtain a flowable UHPC cement-containing paste of uniform plasticity, wherein said two-part high-range water-reducing admixture combination is a high-range water-reducing admixture and a superplasticizer+HRWR liquid admixture, and wherein said high-range water-reducing admixture ranges is about 20-40 fluid ounces per 100 lb of said resultant cement-containing paste, and said superplasticizer+HRWR admixture amount ranges from 50-60 fluid ounces per 100 lb.

The next step 4. proceeds to mixing microfibers into the flowable UHPC cement-containing paste of uniform plasticity to obtain a microfiber reinforced UHPC paste, wherein the microfibers have an average length of 10-15 mm, and wherein the microfibers are selected from the group consisting of steel microfibers, basalt chopped strand fibers, glass chopped strand fibers, carbon chopped strand fibers, synthetic polymer chopped strand fibers, natural chopped strand fibers, and combinations thereof.

### Example—Highly Sustainable 50% SiFu Replacement UHPC Concrete

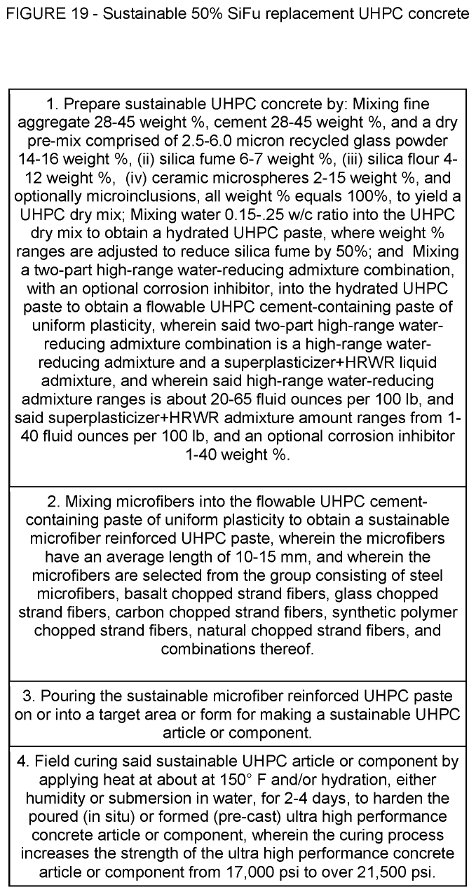

FIG. 19 illustrates in a non-limiting preferred embodiment, that the invention includes articles and components manufactured having a large percentage of 2.5-6.0 micron recycled glass powder that is used in a replacement of up to 50% of the silica fume and up to 25% of the ceramic microspheres, which makes a UHPC that is significantly more sustainable and environmentally friendly. According, the process for making highly sustainable UHPC comprises: Step 1. Mixing fine aggregate 28-45 weight %, cement 28-45 weight %, and a dry pre-mix comprised of 2.5-6.0 micron recycled glass powder 14.0-16.0 weight %, (ii) silica fume 6-7 weight %, (iii) silica flour 4-12 weight %, (iv) ceramic microspheres 2-4 weight %, and optionally microinclusions, all weight % equals 100%, to yield a UHPC dry mix; Step 2. Mixing water 0.15-0.25 w/c ratio into the UHPC dry mix to obtain a hydrated UHPC paste; and Step 3. Mixing a two-part high-range water-reducing admixture combination, with an optional corrosion inhibitor, into the hydrated UHPC paste to obtain a flowable UHPC cement-containing paste of uniform plasticity, wherein said two-part high-range water-reducing admixture combination is a high-range water-reducing admixture and a superplasticizer+HRWR liquid admixture, and wherein said high-range water-reducing admixture ranges is about 20-65 fluid ounces per 100 lb of said resultant cement-containing paste, and said superplasticizer+HRWR admixture amount ranges from 1-40 fluid ounces per 100 lb.

The next step 4. proceeds to mixing microfibers into the flowable UHPC cement-containing paste of uniform plasticity to obtain a microfiber reinforced UHPC paste, wherein the microfibers have an average length of 10-15 mm, and wherein the microfibers are selected from the group consisting of steel microfibers, basalt chopped strand fibers, glass chopped strand fibers, carbon chopped strand fibers, synthetic polymer chopped strand fibers, natural chopped strand fibers, and combinations thereof.

### Example—Reduced Cost UHPC Concrete

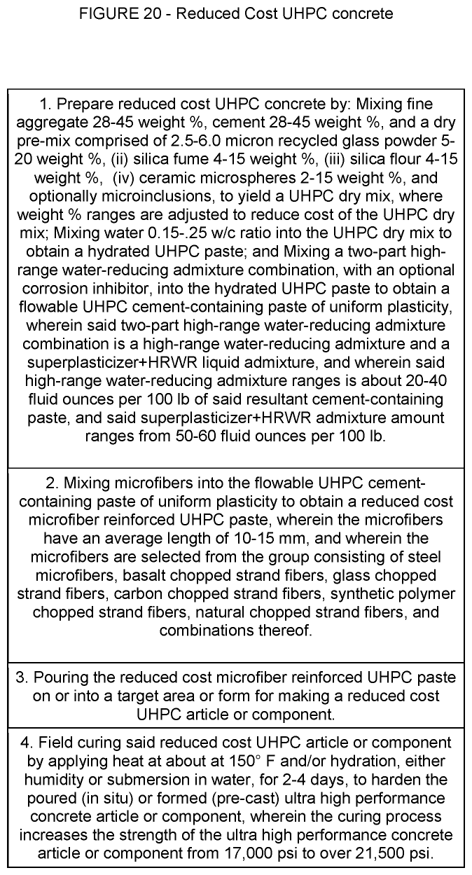

FIG. 20 illustrates in a non-limiting preferred embodiment, that the invention provides articles and components manufactured having a large percentage of 2.5-6.0 micron recycled glass powder that is used in a replacement of up to 50% of the silica fume, up to 50% of the silica flour, and up to 50% of the ceramic microspheres, which makes a UHPC that is significantly more economical, sustainable and environmentally friendly. According, the process for making reduced cost UHPC comprises: Step 1. Mixing fine aggregate 28-45 weight %, cement 28-45 weight %, and a dry pre-mix comprised of 2.5-6.0 micron recycled glass powder 5-20 weight %, (ii) silica fume 4-15 weight %, (iii) silica flour 4-15 weight %, (iv) ceramic microspheres 2-15 weight %, and optionally microinclusions, to yield a UHPC dry mix, where weight % ranges are adjusted to reduce cost of the UHPC dry mix; Step 2. Mixing water 0.15-0.25 w/c ratio into the UHPC dry mix to obtain a hydrated UHPC paste; and Step 3. Mixing a two-part high-range water-reducing admixture combination, with an optional corrosion inhibitor, into the hydrated UHPC paste to obtain a flowable UHPC cement-containing paste of uniform plasticity, wherein said two-part high-range water-reducing admixture combination is a high-range water-reducing admixture and a superplasticizer+HRWR liquid admixture, and wherein said high-range water-reducing admixture ranges is about 20-40 fluid ounces per 100 lb of said resultant cement-containing paste, and said superplasticizer+HRWR admixture amount ranges from 50-60 fluid ounces per 100 lb.

The next step 4. proceeds to mixing microfibers into the flowable UHPC cement-containing paste of uniform plasticity to obtain a microfiber reinforced UHPC paste, wherein the microfibers have an average length of 10-15 mm, and wherein the microfibers are selected from the group consisting of steel microfibers, basalt chopped strand fibers, glass chopped strand fibers, carbon chopped strand fibers, synthetic polymer chopped strand fibers, natural chopped strand fibers, and combinations thereof.

### Example—20H-50S Mix

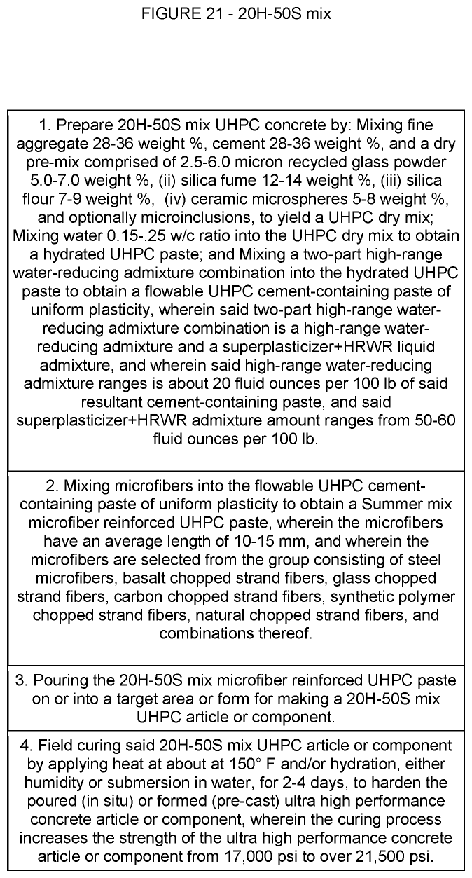

FIG. 21 illustrates in a non-limiting preferred embodiment, the invention provides for making a specialty mix wherein the HRWR admix is reduced by 50%. Thus, the process for a specialty mix provides: Step 1. Mixing fine aggregate 28-36 weight %, cement 28-36 weight %, and a dry pre-mix comprised of 2.5-6.0 micron recycled glass powder 5-7 weight %, (ii) silica fume 12-14 weight %, (iii) silica flour 7-9 weight %, (iv) ceramic microspheres 5-8 weight %, and optionally microinclusions, to yield a UHPC dry mix; Step 2. Mixing water 0.15-0.25 w/c ratio into the UHPC dry mix to obtain a hydrated UHPC paste; and Step 3. Mixing a two-part high-range water-reducing admixture combination into the hydrated UHPC paste to obtain a flowable UHPC cement-containing paste of uniform plasticity, wherein said two-part high-range water-reducing admixture combination is a high-range water-reducing admixture and a superplasticizer+HRWR liquid admixture, and wherein said high-range water-reducing admixture ranges is about 20 fluid ounces per 100 lb of said resultant cement-containing paste, and said superplasticizer+HRWR admixture amount ranges from 50-60 fluid ounces per 100 lb.

The next step 4. proceeds to mix microfibers into the flowable UHPC cement-containing paste of uniform plasticity to obtain a microfiber reinforced UHPC paste, wherein the microfibers have an average length of 10-15 mm, and wherein the microfibers are selected from the group consisting of steel microfibers, basalt chopped strand fibers, glass chopped strand fibers, carbon chopped strand fibers, synthetic polymer chopped strand fibers, natural chopped strand fibers, and combinations thereof.

### Example—40H-50S Mix

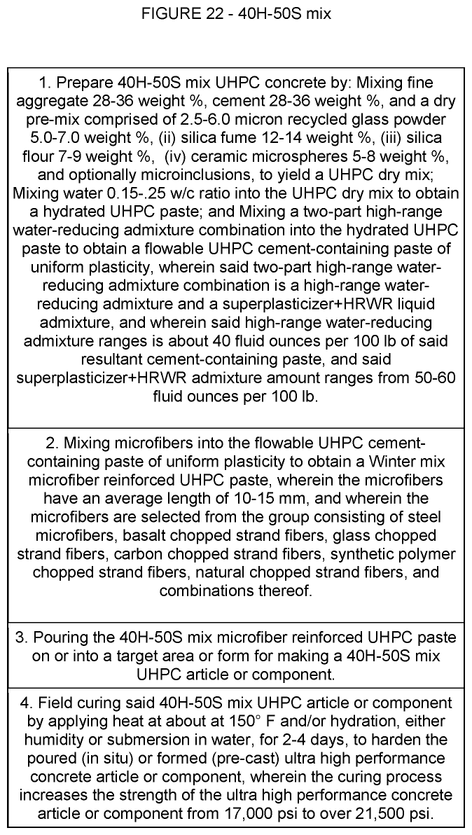

FIG. 22 illustrates in a non-limiting preferred embodiment, the invention provides for making a specialty mix. Step 1. Mixing fine aggregate 28-36 weight %, cement 28-36 weight %, and a dry pre-mix comprised of 2.5-6.0 micron recycled glass powder 5-7 weight %, (ii) silica fume 12-14 weight %, (iii) silica flour 7-9 weight %, (iv) ceramic microspheres 5-8 weight %, and optionally microinclusions, to yield a UHPC dry mix; Step 2. Mixing water 0.15-0.25 w/c ratio into the UHPC dry mix to obtain a hydrated UHPC paste; and Step 3. Mixing a two-part high-range water-reducing admixture combination into the hydrated UHPC paste to obtain a flowable UHPC cement-containing paste of uniform plasticity, wherein said two-part high-range water-reducing admixture combination is a high-range water-reducing admixture and a superplasticizer+HRWR liquid admixture, and wherein said high-range water-reducing admixture ranges is about 40 fluid ounces per 100 lb of said resultant cement-containing paste, and said superplasticizer+HRWR admixture amount ranges from 50-60 fluid ounces per 100 lb.

The next step 4. proceeds to mixing microfibers into the flowable UHPC cement-containing paste of uniform plasticity to obtain a microfiber reinforced UHPC paste, wherein the microfibers have an average length of 10-15 mm, and wherein the microfibers are selected from the group consisting of steel microfibers, basalt chopped strand fibers, glass chopped strand fibers, carbon chopped strand fibers, synthetic polymer chopped strand fibers, natural chopped strand fibers, and combinations thereof.

Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

Where schematics and/or embodiments described above indicate certain components arranged in certain orientations or positions, the arrangement of components may be modified. While the embodiments have been particularly shown and described, it will be understood that various changes in form and details may be made. Any portion of the apparatus and/or methods described herein may be combined in any combination, except mutually exclusive combinations.

The embodiments described herein can include various combinations and/or sub-combinations of the functions, components, and/or features of the different embodiments described. Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

It is therefore to be understood that within the scope of the appended claims, the invention may be practiced otherwise than as described. Accordingly, all such modifications are intended to be included within the scope of this invention as defined in the following claims.

What is claimed as the invention:

1. A process for making microfiber reinforced ultra high performance concrete (UHPC) paste with recycled glass, comprising: mixing (i) fine aggregate (sand), (ii) cement, and a dry pre-mix comprised of (iii) 2.5-6.0 micron recycled glass powder, (iv) silica fume, (v) silica flour, and (vi) ceramic microspheres with average diameter 4 microns, to obtain a UHPC dry mix, followed by adding water only 0.15-0.25 water/cement ratio, with further mixing, then adding a two-part admix comprised of high-range water-reducing admix and a superplasticizer admix, and optionally a corrosion inhibitor, to obtain a UHPC cement-containing paste of uniform plasticity, and finally mixing microfibers to the UHPC cement-containing paste of uniform plasticity to obtain a microfiber reinforced UHPC paste.

2. The process of claim 1, wherein the (i) fine aggregate is 28-45 weight %, the (ii) portland cement is 28-45 weight %, and the dry pre-mix is comprised of (iii) 2.5-6.0 micron (D50) recycled glass powder 5-15 weight %, (iv) silica fume 4-12 weight %, (v) silica flour 7.0-9.0 weight %, (vi) ceramic microspheres 5-15 weight %, wherein a total of all dry weight % equals 100%.

3. The process of claim 1, wherein the (i) fine aggregate is 35 weight %, the (ii) portland cement is 34 weight %, and the dry pre-mix is comprised of (iii) 2.5-6.0 micron (D50) recycled glass powder 12.0-14.0 weight %, (iv) silica fume 0-2 weight %, (v) silica flour 7.0-9.0 weight %, (vi) ceramic microspheres 5-15 weight %, wherein a total of all dry weight % equals 100%.

4. The process of claim 1, wherein the (i) fine aggregate is 35 weight %, the (ii) portland cement is 34 weight %, and the dry pre-mix is comprised of (iii) 2.5-6.0 micron (D50) recycled glass powder 14-16 weight %, (iv) silica fume 6-7 weight %, (v) silica flour 4-12 weight %, (vi) ceramic microspheres 2.0-4.0 weight %, wherein a total of all dry weight % equals 100%.

5. The process of claim 1, wherein the (i) fine aggregate is 35 weight %, the (ii) portland cement is 34 weight %, and the dry pre-mix is comprised of (iii) 2.5-6.0 micron (D50) recycled glass powder 17-19 weight %, (iv) silica fume 6-7 weight %, (v) silica flour 3.5-4.5 weight %, (vi) ceramic microspheres 2-4 weight %, wherein a total of all dry weight % equals 100%.

6. The process according to claim 1, wherein the recycled glass powder has an average particle size (D50) of about 4.0 micron.

7. The process of claim 1, wherein water is added at a 0.17-0.19 w/c ratio into the UHPC dry mix.

8. The process of claim 1, wherein the microfibers are 6-20 mm in length at 5-10 weight % to the UHPC cement-containing paste.

9. The process of claim 1, wherein the microfibers are 10-20 mm in length and are selected from the group consisting of steel fiber, and chopped strand fiber.

10. The process of claim 1, wherein the microfibers are steel microfibers 6-13 mm in length and average 0.2 mm in diameter.

11. The process of claim 1, wherein the microfibers are chopped strand fiber 6-20 mm in length and selected from the group consisting of basalt fiber, glass fiber, carbon fiber, synthetic polymer fiber, natural fiber, and multiple strand threads of one or more of the above.

12. The process according to claim 1, wherein the process is performed in a redi-mix truck at a volume of about 8-11 cu. yds. (about 6-8 m3) and a total mixing time of 6-20 minutes.

13. The process according to claim 1, wherein the process is performed in a stationary mixer at a volume of about 1-3 cu. yds. (about 0.765-2.3 m3) and a total mixing time of 5-6 minutes.

14. The process according to claim 1, wherein said high-range water-reducing admixture amount ranges from about 20-60 fluid ounces per 100 lb of said microfiber reinforced UHPC paste, and said superplasticizer+HRWR admixture amount ranges from 20-60 fluid ounces per 100 lb of said microfiber reinforced UHPC paste, and wherein said corrosion inhibitor is calcium nitrate or calcium nitrite.

15. The process according to claim 1, wherein said high-range water-reducing admixture amount is a Summer mix of about 20 fluid ounces per 100 lb of said microfiber reinforced UHPC paste, and said superplasticizer+HRWR admixture amount ranges from 50-60 fluid ounces per 100 lb of said microfiber reinforced UHPC paste.

16. The process according to claim 1, wherein said high-range water-reducing admixture amount is a Winter mix of about 40 fluid ounces per 100 lb of said microfiber reinforced UHPC paste, and said superplasticizer+HRWR admixture amount ranges from 50-60 fluid ounces per 100 lb of said microfiber reinforced UHPC paste.

17. A microfiber reinforced UHPC paste made according to the process of claim 1.

18. An article made according to the process of claim 1.

19. The article according to claim 18, wherein the article is a component selected from the group consisting of: an overlay, a joint fill, a beam end-cap, a plate, a channel, a pipe, a tube, an I-beam section, an H-beam component, a WF-section, a smooth column, a fluted column, a connector, a precast highway slab, a precast railroad tie, a precast parking block, a precast jersey barrier, a street curb, a sidewalk, a driveway, a drive apron, a guard rail, a bollard, vehicle up-armoring, ballistic armor for walls and doors, an armored roofing tile, a ballistic panel for a building, a ships, an aircraft, a truck, and a passenger vehicle, a ballistic floor tile, a blast-resistant panel, a man-portable panel, a thin armor panel, a forced entry resistant structural elements, a wall, a slab, a truss, a joist, a rafter, a support gusset, a footer, an underflooring, a concrete block, a brick, a panel, a roofing tile, a siding plank, a mounting pad, a paver, a post and pole anchor block, a floor tile, a kitchen tile, a bath tile, a kitchen and bath countertop, a laboratory bench top, a fireplace liner, a veneer, a decking plank, a post, a support, a planter, a paver, a stepping stone, a bench, a fireplace, a gutter, a drainage tile, an in situ poured water conduit and structure, a precast water conduit, in situ poured sewer pipe and structure, a precast sewage pipe, an in situ poured connector, a precast connector, a seawall, a sea barrier block and form, a waterway bridge piling, a waterway bridge span, column, and decking, a building piling, span, column and slab, an undersea piling, an undersea mounting pad, an undersea coffer dam having a cement base and a UHPC cap layer, a harbor dock, a marina piling, a dock, a navigation structure, a lighthouse, a waterway navigation light and structure, a boat launch ramp, a reservoir liner and wall, a mounting pad, a post and pole anchor block, a warehouse slab, a holding pond, a spillway, a silo, a loading dock, a security barrier, a traffic diversion structure, a gatehouse, a solar panel pad, a wind turbine slab, a wind turbine tower, a smokestack, a refractory furnace brick, an oil and gas well cementing for casings, a storage tank pad, a drilling slab, a pump jack slab, a pipeline footer, a spillway for oil and gas, a holding pond for oil and gas, a protective utility box, a security wall, an offshore rig structural component, a power transmission tower, a power substation security wall, a water control dam and aquaduct, a electrical utility pole and tower, an electrical utility (junction) box, a natural gas utility box, a telecommunication utility pole, a telecommunication utility (junction) box, a telecommunication (telephone) pole, and mobile cell phone tower.

20. The article according to claim 18, wherein the article is a component selected from the group consisting of: a vehicle up-armoring component, a ballistic armor component, a blast-resistant panel, a man-portable panel, a thin armor panel, a forced entry resistant structural element, an armored roofing tile, a ballistic wall panel, a ballistic floor tile, a hurricane and tornado resistant structural element, and combinations thereof.

21. The process according to claim 1, comprising forming said microfiber reinforced UHPC paste in the shape of a component, and curing said component by heating and/or hydrating said component.

22. The process according to claim 21, comprising curing said component by: placing in an environment of heat and optionally humidity or submersion at approximately 120-195 °F for about one to about four days, wherein said cured composition component has a compressive strength of at least 17,000-21,500 psi.

23. A heat-cured component made according to the process of claim 22.

24. A method of producing a component of a structure, comprising: (i) Preparing a microfiber reinforced UHPC paste according to the process of claim 1; and (ii) Forming said microfiber reinforced UHPC paste in the shape of said component, and curing by heating and/or hydrating said formed microfiber reinforced UHPC paste.

25. The method of claim 23, wherein said forming is done by techniques selected from the group consisting of: spin casting, extrusion molding, pressure molding, pouring into forms, and combinations thereof.

26. The method of claim 24, wherein said composition component is cured by: applying heat and/or hydration, either humidity or submersion in water, at approximately 120-195 °F for about one to about four days, to harden a poured (in situ) or formed (pre-cast) ultra high performance concrete article, said curing process increasing the strength of the ultra high performance concrete article from 17,000 psi to over 21,500 psi.

27. A process for making UHPC dry pre-mix, comprising: mixing silica fume 20-45 weight %, silica flour 15-25 weight %, and ceramic microspheres 30-65 weight %, to obtain a UHPC dry pre-mix.

28. A UHPC dry mix made according to the process of claim 27.

29. The UHPC dry mix according to claim 27, packaged in a 20-50 lb bag.

30. A process for making UHPC dry pre-mix, comprising: mixing silica fume 20-45 weight %, silica flour 15-25 weight %, ceramic microspheres 17-22 weight %, and 2.5-6.0 micron (D50) recycled glass powder 15-60 weight %, to obtain a UHPC dry pre-mix.

31. A UHPC dry mix made according to the process of claim 30.

32. The UHPC dry mix according to claim 30, packaged in a 20-50 lb bag.

33. The process of claim 30, wherein 2.5-6.0 micron (D50) recycled glass powder comprises 17.24-18.42 weight %, silica fume comprises 41.38-36.84 weight %, silica flour comprises 23.68-24.14 weight %, and ceramic microspheres comprise 17.24-21.05 weight %, wherein a total of all dry weight % equals 100%.

34. The process of claim 30, wherein 2.5-6.0 micron (D50) recycled glass powder comprises 52-60 weight %, silica fume comprises 0-2 weight %, silica flour comprises 23.68-24.14 weight %, and ceramic microspheres comprise 17.24-21.05 weight %, wherein a total of all dry weight % equals 100%.

35. The process of claim 30, wherein 2.5-6.0 micron (D50) recycled glass powder comprises 40-46 weight %, silica fume comprises 18-20 weight %, silica flour comprises 23.68-24.14 weight %, and ceramic microspheres comprise 13-16 weight %, wherein a total of all dry weight % equals 100%.

36. The process of claim 30, wherein 2.5-6.0 micron (D50) recycled glass powder comprises 55-58 weight %, silica fume comprises 18-20 weight %, silica flour comprises 12 weight %, and ceramic microspheres comprise 9-10 weight %, wherein a total of all dry weight % equals 100%.
